(19) United States
(12) Patent Application Publication
(10) Pub. No.: US 2017/0137720 A1
(43) Pub. Date: May 18, 2017

(54) SYSTEM AND PROCESS FOR PRODUCING GASOLINE FROM OXYGENATES

(71) Applicant: ExxonMobil Research and Engineering Company, Annandale, NJ (US)

(72) Inventors: Mohsen N. HARANDI, New Hope, PA (US); Stephen J. McCARTHY, Center Valley, PA (US)

(21) Appl. No.: 15/341,404

(22) Filed: Nov. 2, 2016

Related U.S. Application Data
(60) Provisional application No. 62/256,810, filed on Nov. 18, 2015.

(51) Int. Cl. C10G 3/00; B01J 29/40

(52) U.S. Cl. CPC C10G 3/49; B01J 29/40; C10G 2300/202; C10G 2400/02; B01J 2229/16

(57) ABSTRACT

Processes and systems for converting an oxygenate feedstock to a hydrocarbon product, selectivated catalysts and processes for reducing off-spec gasoline production during start-up are provided herein.

### CROSS-REFERENCE TO RELATED APPLICATIONS

This application claims priority to U.S. Provisional Application Ser. No. 62/256,810 filed on Nov. 18, 2015, herein incorporated by reference in its entirety.

### FIELD

The present invention relates to converting an oxygenate feedstock, such as methanol and dimethyl ether, in a reactor containing a catalyst, such as a selectivated zeolite, to hydrocarbons, such as gasoline boiling components.

### BACKGROUND

Processes for converting lower oxygenates such as methanol and dimethyl ether (DME) to hydrocarbons are known and have become of great interest because they offer an attractive way of producing liquid hydrocarbon fuels, especially gasoline, from sources which are not petrochemical feeds. In particular, they provide a way by which methanol and DME can be converted to gasoline boiling components, olefins and aromatics in good yields. Olefins and aromatics are valuable chemical products and can serve as feeds for the production of numerous important chemicals and polymers. Because of the limited supply of competitive petroleum feeds, the opportunities to produce low cost olefins from petroleum feeds are limited. However, methanol may be readily obtained from coal by gasification to synthesis gas and conversion of the synthesis gas to methanol by well-established industrial processes. As an alternative, the methanol may be obtained from natural gas or biomass by other conventional processes.

Available technology to convert methanol and other lower oxygenates to hydrocarbon products, such as gasoline, also results in the undesirable production of durene as a byproduct. When gasoline contains durene in amounts above ˜12 wt. % problems, such as solidification of gasoline, can occur. Additionally, a vehicle's performance can be affected by gasoline used with higher levels of durene. Thus, methanol to gasoline conversion processes can require additional processing units to lower durene content to acceptable levels (e.g., below ˜12 wt. %). Known processes for reducing durene content can include heavy gasoline treatment (HGT). HGT requires separation into heavy and light gasoline fractions, where the heavy gasoline is hydro-treated to reduce durene content. The treated heavy gasoline and light gasoline then require blending to produce a final product. The system required for HGT is a significant added cost, in terms of additional machinery and energy needed, in production of gasoline from oxygenates. Therefore, if the amount of durene produced during the conversion process could be reduced, the need for further processing (e.g., HGT) would be eliminated. However, achieving a lower durene content in the oxygenate conversion process remains difficult. Therefore, there is a need to provide systems and processes that can convert an oxygenate to hydrocarbons with a lower durene content so as to eliminate the need for the further processing, such as HGT.

### SUMMARY

It has been found that a lower durene content can be achieved in systems and processes for converting an oxygenate (e.g., methanol) to hydrocarbons (e.g., a C₅₊ gasoline product) by utilizing a catalyst material in the conversion reaction, wherein the catalyst material may be selectivated (e.g., a selectivated zeolite).

Thus, in one aspect, embodiments of the invention provide a process for converting an oxygenate feedstock to a hydrocarbon product comprising and/or consisting essentially of: feeding the oxygenate feedstock to a reactor under conditions to convert at least a portion of the oxygenate feedstock to the hydrocarbon product in a reactor effluent, wherein the reactor comprises a catalyst selected from the group consisting of a selectivated zeolite, a SAPO, a selectivated SAPO, an ALPO and a selectivated ALPO, and wherein a hydrocarbon portion of reactor effluent comprises less than about 8 wt. % durene and less than about 0.5 wt. % C₁₂₊ aromatics; and separating a C₅₊ gasoline product from the reactor effluent.

In still another aspect, embodiments of the invention provide a process for converting an oxygenate feedstock to a hydrocarbon product comprising: feeding the oxygenate feedstock to a reactor under conditions to convert at least a portion of the oxygenate feedstock to the hydrocarbon product in a reactor effluent, wherein the reactor comprises a silicon selectivated zeolite catalyst, and wherein a hydrocarbon portion of the reactor effluent comprises less than about 2.5 wt. % durene and less than about 0.5 wt. % C₁₂₊ aromatics prior to: (i) separating a C₅₊ gasoline product from the reactor effluent; and/or (ii) heavy gasoline treatment of the reactor effluent.

In still another aspect, embodiments of the invention provide a process for reducing off-spec gasoline production during start-up of an MTG conversion process comprising: at start-up feeding a feedstock comprising methanol and/or dimethylether to a reactor under conditions to convert at least a portion of the feedstock to a C₅₊ gasoline product in a reactor effluent, wherein the reactor comprises a silicon selectivated zeolite catalyst, and wherein a hydrocarbon portion of the reactor effluent comprises less than about 2.5 wt. % durene and less than about 0.5 wt. % C₁₂₊ aromatics.

In still another aspect, embodiments of the invention provide a system for converting an oxygenate feedstock to a C₅₊ gasoline product comprising and/or consisting essentially of: a reactor comprising: an oxygenate feedstock stream and an inlet for the oxygenate feedstock stream; a catalyst selected from the group consisting of a selectivated zeolite, a SAPO, a selectivated SAPO, an ALPO and a selectivated ALPO; a reactor effluent stream and an outlet for the reactor effluent stream, wherein a hydrocarbon portion of the reactor effluent stream comprises less than about 8.0 wt. % durene and less than about 0.5 wt. % C₁₂₊ aromatics; and a separation system in fluid connection with the reactor for separating the C₅₊ gasoline product from the reactor effluent stream comprising: an inlet for the reactor effluent stream; a C₅₊ gasoline product stream and an outlet for the C₅₊ gasoline product stream.

In still another aspect, embodiments of the invention provide a silicon selectivated zeolite catalyst for use in oxygenate conversion to a hydrocarbon product, wherein the hydrocarbon product produced during the oxygenate conversion has a durene content of less than about 2.5 wt. %, a benzene content of at least about 4.0 wt. % and optionally a C₁₂₊ aromatics content of less than 0.5 wt. %.

In still another aspect, embodiments of the invention provide a methanol-to-gasoline (MTG) hydrocarbon product comprising a durene content of less than about 2.5 wt. % and a benzene content of at least about 4.0 wt. % at one or more of the following: a. prior to separating a C₅₊ gasoline product from the MTG hydrocarbon product; b. prior to heavy gasoline treatment of the MTG hydrocarbon product; and/or c. produced directly in an MTG reactor.

In still another aspect, embodiments of the invention provide an MTG hydrocarbon product comprising a durene content of less than about 2.5 wt. % and a benzene content of at least about 4.0 wt. %, wherein the MTG hydrocarbon product is present in an MTG reactor.

In still another aspect, embodiments of the invention provide an MTG reactor comprising a silicon selectivated zeolite catalyst; and an MTG hydrocarbon product comprising a durene content of less than about 2.5 wt. % and a benzene content of at least about 4.0 wt. %.

Other embodiments, including particular aspects of the embodiments summarized above, will be evident from the detailed description that follows.

### BRIEF DESCRIPTION OF THE DRAWINGS

FIG. 1 illustrates conversion and/or selectivity for methanol conversion to hydrocarbons using a silicon selectivated zeolite catalyst selectivated via moderate silicon impregnation treatments.

FIG. 2 illustrates conversion and/or selectivity for methanol conversion to hydrocarbons using a silicon selectivated zeolite catalyst selectivated via severe silicon impregnation treatments.

### DETAILED DESCRIPTION

In various aspects of the invention, processes and systems for converting an oxygenate feedstock to a hydrocarbon product, selectivated catalysts and processes for reducing off-spec gasoline production during start-up are provided.

### I. DEFINITIONS

To facilitate an understanding of the present invention, a number of terms and phrases are defined below.

As used in the present disclosure and claims, the singular forms “a,” “an,” and “the” include plural forms unless the context clearly dictates otherwise.

Wherever embodiments are described herein with the language “comprising,” otherwise analogous embodiments described in terms of “consisting of” and/or “consisting essentially of” are also provided.

The term “and/or” as used in a phrase such as “A and/or B” herein is intended to include “A and B”, “A or B”, “A”, and “B”.

As used herein, the term “about” refers to a range of values of plus or minus 10% of a specified value. For example, the phrase “about 200” includes plus or minus 10% of 200, or from 180 to 220.

As used herein, the term “durene” refers to 1,2,4,5-tetramethylbenzene (C₆H₂(CH₃)₄).

As used herein, the term “reactor” refers to any vessel(s) in which a chemical reaction occurs. Reactor includes both distinct reactors as well as reaction zones within a single reactor apparatus and as applicable, reaction zones across multiple reactors. In other words and as is common, a single reactor may have multiple reaction zones. Where the description refers to a first and second reactor, the person of ordinary skill in the art will readily recognize such reference includes a single reactor having first and second reaction zones. Likewise, a first reactor effluent and a second reactor effluent will be recognized to include the effluent from the first reaction zone and the second reaction zone of a single reactor, respectively. Nonlimiting examples of reactors include a fluidized bed reactor, a moving bed reactor and a fixed bed reactor.

As used herein, the term “fluidized bed reactor” refers to a reactor where a volume of a particulate material comprising a catalyst material is generally kept afloat (“fluidized”) by flowing a fluid (gas or liquid) through the reactor at a sufficient velocity. The fluid typically comprises the reactants allowing for contact and mixing between the reactants and the particulate material (e.g., catalyst) to facilitate the reaction. The fluidized bed reactor may include a fixed fluid bed operating under turbulent regime (with a Reynold's number greater than about 2,000) in a pressure vessel suitable to operate under methanol-to-gasoline operating conditions. The fluid-bed reactor may comprise of a riser reactor and a stripping section. Cyclones or other gas solid separation equipment may be placed inside the reactor vessel.

As used herein, the term “moving bed reactor” refers to a reactor where a particulate material comprising a catalyst material travels slowly through the reactor and may be removed from the reactor. Typically the catalyst material enters at one end of the reactor and flows out the opposite end of the reactor. The moving bed reactor may be connected to a regeneration system as described above to regenerate spent catalysts. The regenerated catalyst may then be returned to the moving bed reactor for further use in the reaction.

As used herein, the term “fixed bed reactor” or “packed bed reactor” refers to a reactor where a particulate material comprising a catalyst material is substantially immobilized within the reactor and reactant(s) flows downward or radially through the catalyst bed. A fixed bed reactor may include one more vessels containing the particulate material. The vessel may be cylindrical or spherical. It may be horizontally oriented or vertically oriented.

As used herein, the phrases “light stream” and “heavy stream” are relative. A “light stream” will generally have a mean boiling point lower than the mean boiling point of a “heavy stream.” Without limiting the foregoing definition, in some embodiments, the light stream may comprise a majority of molecules having 10 or fewer carbon atoms, e.g., 9 or fewer, 8 or fewer, 7 or fewer, 6 or fewer, 5 or fewer, 4 or fewer, 3 or fewer, 2 or fewer, 1 or fewer, or no carbon atoms.

As used herein the phrase “at least a portion of” means >0 to 100.0 wt. % of the process stream or composition to which the phrase refers. The phrase “at least a portion of” refers to an amount ≦about 1.0 wt. %, ≦about 2.0 wt. %, ≦about 5.0 wt. %, ≦about 10.0 wt. %, ≦about 20.0 wt. %, ≦about 25.0 wt. %, ≦about 30.0 wt. %, ≦about 40.0 wt. %, ≦about 50.0 wt. %, ≦about 60.0 wt. %, ≦about 70.0 wt. %, ≦about 75.0 wt. %, ≦about 80.0 wt. %, ≦about 90.0 wt. %, ≦about 95.0 wt. %, ≦about 98.0 wt. %, ≦about 99.0 wt. %, or ≦about 100.0 wt. %. Additionally or alternatively, the phrase “at least a portion of” refers to an amount ≧about 1.0 wt. %, ≧about 2.0 wt. %, ≧about 5.0 wt. %, ≧about 10.0 wt. %, ≧about 20.0 wt. %, ≧about 25.0 wt. %, ≧about 30.0 wt. %, ≧about 40.0 wt. %, ≧about 50.0 wt. %, ≧about 60.0 wt. %, ≧about 70.0 wt. %, ≧about 75.0 wt. %, ≧about 80.0 wt. %, ≧about 90.0 wt. %, ≧about 95.0 wt. %, ≧about 98.0 wt. %, ≧about 99.0 wt. %, or about 100.0 wt. %. Ranges expressly disclosed include combinations of any of the above-enumerated values; e.g., about 10.0 to about 100.0 wt. %, about 10.0 to about 98.0 wt. %, about 2.0 to about 10.0 wt. %, about 40.0 to 60.0 wt. %, etc.

As used herein, the term “hydrocarbon” refers to materials that are primarily composed of hydrogen and carbon atoms. Additionally, a hydrocarbon may also include other elements, such as, but not limited to, halogens, metallic elements, nitrogen, oxygen, and/or sulfur. Hydrocarbons may be aliphatic (straight chain or branched hydrocarbons), and cyclic (closed ring) hydrocarbons.

As used herein, the term “aromatic” refers to unsaturated cyclic hydrocarbons having 5 to 20 carbon atoms, particularly from 8 to 20 carbon atoms, particularly from 5 to 12 carbon atoms. As used herein, the term “C₁₂₊ aromatics” refers to aromatics having 12 to 20 carbon atoms. Exemplary aromatics include, but are not limited to benzene, toluene, xylenes, mesitylene, ethylbenzenes, cumene, naphthalene, methylnaphthalene, dimethylnaphthalenes, ethylnaphthalenes, acenaphthalene, anthracene, phenanthrene, tetraphene, naphthacene, benzanthracenes, fluoranthrene, pyrene, chrysene, triphenylene, and the like, and combinations thereof. The aromatic may comprise monocyclic, bicyclic, tricyclic, and/or polycyclic rings (in some embodiments, at least monocyclic rings, only monocyclic and bicyclic rings, or only monocyclic rings) and may be fused rings. As used herein, the term “olefin” refers to an unsaturated hydrocarbon chain length of from 2 to 30 carbon atoms, particularly from 2 to 12 carbon atoms, particularly from 2 to 8 carbon atoms, particularly from 2 to 6 carbon atoms, particularly from 2 to 4 carbons atoms, containing at least one carbon-to-carbon double bond, e.g., ethylene, propylene, butylene, butene-1, pentylene, pentene-1,4-methyl-pentene-1, hexene-1, octene-1, and decene-1, preferably ethylene, propylene, butene-1, pentene-1,4-methyl-pentene-1, hexene-1, octene-1, and isomers thereof. The olefin may be straight-chain or branched-chain. Other non-limiting examples of olefins can include unsaturated monomers, diolefins having 4 to 18 carbon atoms, conjugated or nonconjugated dienes, polyenes, vinyl monomers, and cyclic olefins. “Olefin” is intended to embrace all structural isomeric forms of olefins. As used herein, the term “light olefin” refers to olefins having 2 to 4 carbon atoms (i.e., ethylene, propylene, and butenes).

As used herein, the term “paraffin” refers to a saturated hydrocarbon chain of 1 to about 12 carbon atoms in length, such as, but not limited to methane, ethane, propane and butane. The paraffin may be straight-chain or branched-chain. “Paraffin” is intended to embrace all structural isomeric forms of paraffins. As used herein, the term “light paraffin” refers to paraffins having 1 to 4 carbon atoms (i.e., methane, ethane, propane and butane).

As used herein, the term “oxygenate” refers to oxygen-containing compounds having from 1 to 50 carbon atoms, particularly from 1 to 20 carbon atoms, particularly from 1 to 10 carbon atoms, particularly from 1 to 4 carbon atoms. Exemplary oxygenates include alcohols, ethers, carbonyl compounds, e.g., aldehydes, ketones and carboxylic acids, and mixtures thereof. Particular non-limiting examples of oxygenates include methanol, ethanol, dimethyl ether, diethyl ether, methylethyl ether, di-isopropyl ether, dimethyl carbonate, dimethyl ketone, formaldehyde, acetic acid, and the like, and combinations thereof.

As used herein, the term “alcohol” refers to a hydroxy group (—OH) bound to a saturated carbon atom (i.e., an alkyl). Examples of the alkyl portion of the alcohol include, but are not limited to propyl, butyl, pentyl, hexyl, iso-propyl, iso-butyl, sec-butyl, tert-butyl, etc. The alcohol may be straight or branched. “Alcohol” is intended to embrace all structural isomeric forms of an alcohol. Examples of alcohols include, but are not limited to methanol, ethanol, propanol, isopropanol, glycerol, butanol, isobutanol, n-butanol, tert-butanol, pentanol, hexanol and mixtures thereof. As used herein, the term “butanol” encompasses n-butanol, isobutanol and tert-butanol. As used herein, the term “propanol” encompasses 1-propanol and isopropanol. Additionally or alternatively, the alcohol may be independently substituted with a C₁-C₈-alkyl. For example, butanol may be substituted with a methyl group, such as, but not limited to 2-methyl-1-butanol and 3-methyl-2-butanol.

As used herein, the term “C₅₊ gasoline product” refers to a composition comprising C₅-C₁₂ hydrocarbons and/or having a boiling point range within the specifications for motor gasoline (e.g., from about 100° F. to about 400° F.).

### II. CONVERSION OF AN OXYGENATE FEEDSTOCK TO A HYDROCARBON PRODUCT

In a first embodiment, a process for converting an oxygenate feedstock to a hydrocarbon product is provided

### A. Oxygenate Feedstock

In the process, an oxygenate feedstock is fed into a reactor under conditions to convert at least a portion of the oxygenate feedstock to the hydrocarbon product in a reactor effluent, wherein the reactor comprises a catalyst. The oxygenate feedstock may comprise various oxygenates including, but not limited to alcohols, ethers, carbonyl compounds, e.g., aldehydes, ketones and carboxylic acids, and mixtures thereof. In particular, the oxygenate feedstock comprises methanol, dimethyl ether (DME) or a mixture thereof. The methanol can be obtained from coal, natural gas and biomass by conventional processes. Additionally or alternatively, the oxygenate feedstock may include water. For example, the methanol can be obtained from coal with a water content of about 4% or natural gas with a water content of about 17%.

The amount of oxygenate in the oxygenate feedstock may be ≧10.0 wt. %, ≧about 12.5 wt. %, ≧about 15.0 wt. %, ≧about 20.0 wt. %, ≧about 25.0 wt. %, ≧about 30.0 wt. %, ≧about 35.0 wt. %, ≧about 40.0 wt. %, ≧about 45.0 wt. %, ≧ab out 50.0 wt. %, ≧about 55.0 wt. %, ≧about 60.0 wt. %, ≧about 65.0 wt. %, ≧about 70.0 wt. %, ≧about 75.0 wt. %, ≧about 80.0 wt. %, ≧about 85.0 wt. %, ≧about 90.0 wt. %, ≧about 95.0 wt. %, ≧about 99.0 wt. %, ≧about 99.5 wt. %, or about 100.0 wt. %. Additionally or alternatively, the amount of oxygenate in the oxygenate feedstock may be ≦about 10.0 wt. %, ≦about 12.5 wt. %, ≦about 15.0 wt. %, ≦about 20.0 wt. %, ≦about 25.0 wt. %, ≦about 30.0 wt. %, ≦about 35.0 wt. %, ≦about 40.0 wt. %, ≦about 45.0 wt. %, ≦about 50.0 wt. %, ≦about 55.0 wt. %, ≦about 60.0 wt. %, ≦about 65.0 wt. %, ≦about 70.0 wt. %, ≦about 75.0 wt. %, ≦about 80.0 wt. %, ≦about 85.0 wt. %, ≦about 90.0 wt. %, ≦about 95.0 wt. %, ≦about 99.0 wt. %, ≦about 99.5 wt. %, or ≦about 100.0 wt. %. Ranges expressly disclosed include combinations of any of the above-enumerated values; e.g., about 10.0 to about 100.0 wt. %, about 12.5 to about 99.5 wt. %, about 20.0 to about 90.0, about 50.0 to about 99.0 wt. %, etc.

Additionally or alternatively, one or more other compounds may be present in the oxygenate feedstock. The other compounds may have 1 to about 50 carbon atoms, e.g., 1 to about 20 carbon atoms, 1 to about 10 carbon atoms, or 1 to about 4 carbon atoms. Typically, although not necessarily, such other compounds include one or more heteroatoms other than oxygen, including but not limited to amines, halides, mercaptans, sulfides, and the like.

Particular such compounds include alkyl-mercaptans (e.g., methyl mercaptan and ethyl mercaptan), alkyl-sulfides (e.g., methyl sulfide), alkyl-amines (e.g., methyl amine), and alkyl-halides (e.g., methyl chloride and ethyl chloride). The amount of such other compounds in the oxygenate feedstock may be ≦about 2.0 wt. %, ≦about 5.0 wt. %, ≦about 10.0 wt. %, ≦about 15.0 wt. %, ≦about 20.0 wt. %, ≦about 25.0 wt. %, ≦about 30.0 wt. %, ≦about 35.0 wt. %, ≦about 40.0 wt. %, ≦about 45.0 wt. %, ≦about 50.0 wt. %, ≦about 60.0 wt. %, ≦about 75.0 wt. %, ≦about 90.0 wt. %, or ≦about 95.0 wt. %. Additionally or alternatively, the amount of such other compounds in the oxygenate feedstock may be ≧about 2.0 wt. %, ≧about 5.0 wt. %, ≧about 10.0 wt. %, ≧about 15.0 wt. %, ≧about 20.0 wt. %, ≧about 25.0 wt. %, ≧about 30.0 wt. %, ≧about 35.0 wt. %, ≧about 40.0 wt. %, ≧about 45.0 wt. %, ≧about 50.0 wt. %, ≧about 60.0 wt. %, ≧about 75.0 wt. %, ≧about 90.0 wt. % or ≧about 95.0 wt. %. Ranges expressly disclosed include combinations of any of the above-enumerated values; e.g., about 1.0 to about 10.0 wt. %, about 2.0 to about 5.0 wt. %, about 10.0 to about 95.0 wt. %, about 15.0 to about 90.0 wt. %, about 20.0 to about 75.0 wt. %, about 25.0 to about 60 wt. %, about 30.0 to about 50 wt. %, about 35.0 to about 45 wt. %, etc.

Additionally or alternatively, the oxygenate (e.g., methanol) in the oxygenate feedstock has a conversion to the hydrocarbon product of ≧about 30.0%, ≧about 40.0%, ≧about 50.0%, ≧about 60.0%, ≧about 70.0%, ≧about 75.0%, ≧about 80.0%, ≧about 85.0%, ≧about 90.0%, ≧about 91.0%, ≧about 92.0%, ≧about 93.0%, ≧about 94.0%, ≧about 95.0%, ≧about 96.0%, ≧about 97.0%, ≧about 98.0%, ≧about 99.0%, ≧about 99.1%, ≧about 99.2%, ≧about 99.3%, ≧about 99.4%, ≧about 99.5%, ≧about 99.6%, ≧about 99.7%, ≧about 99.8%, or ≧about 99.9%. Particularly, at least 90.0% of the oxygenate (e.g., methanol) is converted into the hydrocarbon product. Additionally or alternatively, the oxygenate (e.g., methanol) in the oxygenate feedstock has a conversion to the hydrocarbon product of ≦about 30.0%, ≦about 40.0%, ≦about 50.0%, ≦about 60.0%, ≦about 70.0%, ≦about 75.0%, ≦about 80.0%, ≦about 85.0%, ≦about 90.0%, ≦about 91.0%, ≦about 92.0%, ≦about 93.0%, ≦about 94.0%, ≦about 95.0%, ≦about 96.0%, ≦about 97.0%, ≦about 98.0%, ≦about 99.0%, ≦about 99.1%, ≦about 99.2%, ≦about 99.3%, ≦about 99.4%, ≦about 99.5%, ≦about 99.6%, ≦about 99.7%, ≦about 99.8%, or ≦about 99.9%. Ranges expressly disclosed include combinations of any of the above-enumerated values; e.g., about 30.0% to about 99.9%, about 60.0% to about 99.1%, about 85.0% to about 99.0%, about 98.0% to about 99.8%, etc.

Additionally or alternatively, the oxygenate feedstock, particularly where the oxygenate comprises an alcohol (e.g., methanol), may optionally be pre-treated to reduce water content in the oxygenate feedstock. For example, the oxygenate feedstock may be fed to a dehydration apparatus for reducing water content in the oxygenate feedstock, e.g., for catalytic dehydration over e.g., γ-alumina, prior to introduction into the reactor. Further, optionally, at least a portion of any methanol and/or water remaining in the oxygenate feedstock after catalytic dehydration may be separated from the oxygenate feedstock. If desired, such catalytic dehydration may be used to reduce the water content of reactor effluent before it enters a subsequent reactor or reaction zone, e.g., second and/or third reactors as discussed below. Additionally or alternatively, a step of pre-treating the oxygenate feedstock to reduce water content is not present.

### B. Reactor

The oxygenate feedstock is fed into a reactor, which may comprise at least an inlet for the oxygenate feedstock, a catalyst and an outlet for a reactor effluent. Suitable reactors include, but are not limited to a moving bed reactor, a fixed bed reactor and a fluidized bed reactor. Particularly, the reactor is a fluidized bed reactor. Additionally or alternatively, the reactor may include one or more reactors having the catalyst therein. Where the reactor includes more than one reactor, the reactors may be arranged in any suitable configuration, e.g., in series, parallel, or series-parallel. The reactor internals can include distributors, baffles, cyclones, strippers and other means to enhance performance of the reaction system.

The reactor is operated under reaction conditions sufficient to convert the oxygenate feedstock to a hydrocarbon product (e.g., C₅₊ gasoline product). In particular, the reactor is operated at a weight hourly space velocity (WHSV, g oxygenate/g catalyst/hour) in the range of from ˜0.1 to ˜12.0 hr⁻¹. The WHSV may be ˜0.1 to ˜11.0 hr⁻¹, ˜0.1 to ˜10.0 hr⁻¹, ˜0.1 to ˜9.0 hr⁻¹, ˜0.1 to ˜7.0 hr⁻¹, ˜0.1 to ˜6.0 hr⁻¹, ˜0.1 to ˜5.0 hr⁻¹, ˜0.1 to ˜4.0 hr⁻¹, ˜0.1 to ˜3.0 hr⁻¹, ˜0.1 to ˜2.0 hr⁻¹, ˜0.1 to ˜1.0 hr⁻¹, ˜0.5 to ˜11.0 hr⁻¹, ˜0.5 to ˜10.0 hr⁻¹, ˜0.5 to ˜9.0 hr⁻¹, ˜0.5 to ˜7.0 hr⁻¹, ˜0.5 to ˜6.0 hr⁻¹, ˜0.5 to ˜5.0 hr⁻¹, ˜0.5 to ˜4.0 hr⁻¹, ˜0.5 to ˜3.0 hr⁻¹, ˜0.5 to ˜2.0 hr⁻¹, ˜0.5 to ˜1.0 hr⁻¹, ˜1.0 to ˜11.0 hr⁻¹, ˜1.0 to ˜10.0 hr⁻¹, ˜1.0 to ˜9.0 hr⁻¹, ˜1.0 to ˜7.0 hr⁻¹, ˜1.0 to ˜6.0 hr⁻¹, ˜1.0 to ˜5.0 hr⁻¹, ˜1.0 to ˜4.0 hr⁻¹, ˜1.0 to ˜3.0 hr⁻¹, ˜1.0 to ˜2.0 hr⁻¹, ˜2.0 to ˜11.0 hr⁻¹, 2.0 to ˜10.0 hr⁻¹, ˜2.0 to ˜9.0 hr⁻¹, ˜2.0 to ˜7.0 hr⁻¹, ˜2.0 to ˜6.0 hr⁻¹, ˜2.0 to ˜5.0 hr⁻¹, ˜2.0 to ˜4.0 hr⁻¹, ˜2.0 to ˜3.0 hr⁻¹, ˜3.0 to ˜11.0 hr⁻¹, ˜3.0 to ˜10.0 hr⁻¹, ˜3.0 to ˜9.0 hr⁻¹, ˜3.0 to ˜7.0 hr⁻¹, ˜3.0 to ˜6.0 hr⁻¹, ˜3.0 to ˜5.0 hr⁻¹, ˜3.0 to ˜4.0 hr⁻¹, ˜4.0 to ˜11.0 hr⁻¹, ˜4.0 to ˜10.0 hr⁻¹, ˜4.0 to ˜9.0 hr⁻¹, 4.0 to ˜7.0 hr⁻¹, ˜4.0 to ˜6.0 hr⁻¹, or about ˜0.50 hr⁻¹.

Additionally or alternatively, temperature of the reactor may be ≧about 400° F. (about 200° C.), ≧about 425° F. (about 215° C.), ≧about 450° F. (about 230° C.), ≧about 475° F. (about 245° C.), ≧about 500° F. (about 260° C.), ≧about 525° F. (about 270° C.), ≧about 550° F. (about 285° C.), ≧about 575° F. (about 300° C.), ≧about 600° F. (about 310° C.), ≧about 625° F. (about 325° C.), ≧about 650° F. (about 340° C.), ≧about 675° F. (about 355° C.), ≧about 700° F. (about 370° C.) ≧about 725° F. (about 385° C.), ≧about 750° F. (about 395° C.), ≧about 775° F. (about 410° C.), ≧about 800° F. (about 425° C.), ≧about 825° F. (about 440° C.), ≧about 850° F. (about 450° C.), ≧about 875° F. (about 465° C.), ≧about 900° F. (about 480° C.), ≧about 925° F. (about 495° C.), ≧about 950° F. (about 510° C.), ≧about 975° F. (about 520° C.), ≧about 1,000° F. (about 535° C.), ≧about 1,025° F. (about 550° C.), ≧about 1,050° F. (about 565° C.), ≧about 1,075° F. (about 575° C.), ≧about 1,100° F. (about 590° C.), ≧about 1,125° F. (about 605° C.), ≧about 1,150° F. (about 620° C.), ≧about 1,175° F. (about 635° C.), or ≧about 1,200° F. (about 645° C.). Additionally or alternatively, the temperature of the reactor may be ≦about 400° F. (about 200° C.), ≦about 425° F. (about 215° C.), ≦about 450° F. (about 230° C.), ≦about 475° F. (about 245° C.), ≦about 500° F. (about 260° C.), ≦about 525° F. (about 270° C.), ≦about 550° F. (about 285° C.), ≦about 575° F. (about 300° C.), ≦about 600° F. (about 310° C.), ≦about 625° F. (about 325° C.), ≦about 650° F. (about 340° C.), ≦about 675° F. (about 355° C.), ≦about 700° F. (about 370° C.)≦about 725° F. (about 385° C.), ≦about 750° F. (about 395° C.), ≦about 775° F. (about 410° C.), ≦about 800° F. (about 425° C.), ≦about 825° F. (about 440° C.), ≦about 850° F. (about 450° C.), ≦about 875° F. (about 465° C.), ≦about 900° F. (about 480° C.), ≦about 925° F. (about 495° C.), ≦about 950° F. (about 510° C.), ≦about 975° F. (about 520° C.), ≦about 1,000° F. (about 535° C.), ≦about 1,025° F. (about 550° C.), ≦about 1,050° F. (about 565° C.), ≦about 1,075° F. (about 575° C.), ≦about 1,100° F. (about 590° C.), ≦about 1,125° F. (about 605° C.), ≦about 1,150° F. (about 620° C.), ≦about 1,175° F. (about 635° C.), or ≦about 1,200° F. (about 645° C.). Ranges of temperatures expressly disclosed include combinations of any of the above-enumerated values, e.g., about 400° F. (about 200° C.) to about 1,200° F. (about 645° C.), about 550° F. (about 285° C.) to about 1,000° F. (about 535° C.), and about 600° F. (about 310° C.) to about 925° F. (about 495° C.), etc. In particular, the temperature in the reactor is about 550° F. (about 285° C.) to about 1,000° F. (about 535° C.).

The above temperatures may be used in combination with a reactor pressure of ≦about 5 psig (about 34 kPa)≦about 10 psig (about 68 kPa), ≦about 25 psig (about 170 kPa), ≦about 50 psig (about 340 kPa), ≦about 75 psig (about 515 kPa), ≦about 100 psig (about 685 kPa), ≦about 125 psig (about 860 kPa), ≦about 150 psig (about 1030 kPa), ≦about 175 psig (about 1205 kPa), ≦about 200 psig (about 1375 kPa), ≦about 225 psig (about 1550 kPa), ≦about 250 psig (about 1720 kPa), ≦about 275 psig (about 1895 kPa), ≦about 300 psig (about 2065 kPa), ≦about 325 psig (about 2240 kPa), ≦about 350 psig (about 2410 kPa), ≦about 375 psig (about 2585 kPa), ≦about 400 psig (about 5755 kPa), ≦about 425 psig (about 2930 kPa), ≦about 450 psig (about 3100 kPa), ≦about 475 psig (about 3275 kPa), ≦about 500 psig (about 3445 kPa), ≦about 525 psig (about 3615 kPa), ≦about 550 psig (about 3790 kPa), ≦about 575 psig (about 3960 kPa), or ≦about 600 psig (about 4135 kPa). Additionally or alternatively, the pressure may be ≧about 5 psig (about 34 kPa) ≧about 10 psig (about 68 kPa), ≧about 25 psig (about 170 kPa), ≧about 50 psig (about 340 kPa), ≧about 75 psig (about 515 kPa), ≧about 100 psig (about 685 kPa), ≧about 125 psig (about 860 kPa), ≧about 150 psig (about 1030 kPa), ≧about 175 psig (about 1205 kPa), ≧about 200 psig (about 1375 kPa), ≧about 225 psig (about 1550 kPa), ≧about 250 psig (about 1720 kPa), ≧about 275 psig (about 1895 kPa), ≧about 300 psig (about 2065 kPa), ≧about 325 psig (about 2240 kPa), ≧about 350 psig (about 2410 kPa), ≧about 375 psig (about 2585 kPa), ≧about 400 psig (about 5755 kPa), ≧about 425 psig (about 2930 kPa), ≧about 450 psig (about 3100 kPa), ≧about 475 psig (about 3275 kPa), ≧about 500 psig (about 3445 kPa), ≧about 525 psig (about 3615 kPa), ≧about 550 psig (about 3790 kPa), ≧about 575 psig (about 3960 kPa), or ≧about 600 psig (about 4135 kPa). Ranges and combinations of temperatures and pressures expressly disclosed include combinations of any of the above-enumerated values, e.g., about 5 psig (about 34 kPa) to about 600 psig (about 4135 kPa), about 10 psig (about 68 kPa) to about 500 psig (about 3445 kPa), about 100 psig (about 685 kPa) to about 475 psig (about 3275 kPa), etc. In particular, the pressure in reactor is about 10 (about 68 kPa) to about 500 psig (about 3445 kPa).

### C. Reactor Effluent

The reactor effluent exiting the reactor may comprise a variety of hydrocarbon compositions produced from the reaction of the oxygenate feedstock in the reactor. The hydrocarbon compositions typically have mixtures of hydrocarbon compounds having from 1 to 30 carbon atoms (C₁-C₃₀ hydrocarbons), from 2 to 20 carbon atoms (C₂-C₂₀ hydrocarbons), from 2 to 15 carbon atoms (C₂-C₁₅ hydrocarbons), from 2 to 10 carbon atoms (C₂-C₁₀ hydrocarbons), from 2 to 8 carbon atoms (C₂-C₈ hydrocarbons), from 2 to 6 carbon atoms (C₂-C₆ hydrocarbons), from 2 to 4 carbon atoms (C₂-C₄ hydrocarbons), from 5 to 12 carbon atoms (C₅-C₁₂ hydrocarbons), and from 5 to 9 carbon atoms (C₅-C₉ hydrocarbons). Particularly, the reactor effluent comprises a C₅₊ gasoline product. The C₅₊ gasoline product may be present in a hydrocarbon portion of the reactor effluent in amount of ≧about 20.0 wt. %, ≧about 25.0 wt. %, ≧about 30.0 wt. %, ≧about 35.0 wt. %, ≧about 40.0 wt. %, ≧about 45.0 wt. %, ≧about 50.0 wt. %, ≧about 55.0 wt. %, ≧about 60.0 wt. %, ≧about 65.0 wt. %, ≧about 70.0 wt. %, ≧about 75.0 wt. %, ≧about 80.0 wt. %, ≧about 85.0 wt. %, ≧about 90.0 wt. %, or ≧about 95.0 wt. %. Additionally or alternatively, the C₅₊ gasoline product may be present in a hydrocarbon portion of the the reactor effluent in amount of ≦about 20.0 wt. %, ≦about 25.0 wt. %, ≦about 30.0 wt. %, ≦about 35.0 wt. %, ≦about 40.0 wt. %, ≦about 45.0 wt. %, ≦about 50.0 wt. %, ≦about 55.0 wt. %, ≦about 60.0 wt. %, ≦about 65.0 wt. %, ≦about 70.0 wt. %, ≦about 75.0 wt. %, ≦about 80.0 wt. %, ≦about 85.0 wt. %, ≦about 90.0 wt. %, or ≦about 95.0 wt. %. Ranges expressly disclosed include combinations of any of the above-enumerated values, e.g., about 20.0 wt. % to about 95.0 wt. %, about 30.0 wt. % to about 75.0 wt. %, about 40.0 wt. % to about 85.0 wt. %, about 50.0 wt. % to about 90.0 wt. %, etc.

Additionally or alternatively, a hydrocarbon portion of the reactor effluent may comprise one or more olefins, e.g., having 2 to 20 carbons atoms, particularly 2 to 8 carbon atoms, and particularly 2 to 5 carbon atoms. The one or more olefins may be present in a hydrocarbon portion of the reactor effluent in amount of ≧about 1.0 wt. %, ≧about 2.0 wt. %, ≧about 3.0 wt. %, ≧about 4.0 wt. %, ≧about 5.0 wt. %, ≧about 6.0 wt. %, ≧about 7.0 wt. %, ≧about 8.0 wt. %, ≧about 9.0 wt. %, ≧about 10.0 wt. %, ≧about 12.0 wt. %, ≧about 14.0 wt. %, ≧about 16.0 wt. %, ≧about 18.0 wt. %, ≧about 20.0 wt. %, ≧about 25.0 wt. %, ≧about 30.0 wt. %, ≧about 35.0 wt. %, ≧about 40.0 wt. %, ≧about 45.0 wt. %, ≧about 50.0 wt. %, ≧about 55.0 wt. %, ≧about 60.0 wt. %, ≧about 65.0 wt. %, ≧about 70.0 wt. %, ≧about 75.0 wt. %, ≧about 80.0 wt. %, ≧about 85.0 wt. %, ≧about 90.0 wt. % or ≧about 95.0 wt. %. Additionally or alternatively, the one or more olefins may be present in a hydrocarbon portion of the reactor effluent in amount of ≦about 1.0 wt. %, ≦about 2.0 wt. %, ≦about 3.0 wt. %, ≦about 4.0 wt. %, ≦about 5.0 wt. %, ≦about 6.0 wt. %, ≦about 7.0 wt. %, ≦about 8.0 wt. %, ≦about 9.0 wt. %, ≦about 10.0 wt. %, ≦about 12.0 wt. %, ≦about 14.0 wt. %, ≦about 16.0 wt. %, ≦about 18.0 wt. %, ≦about 20.0 wt. %, ≦about 25.0 wt. %, ≦about 30.0 wt. %, ≦about 35.0 wt. %, ≦about 40.0 wt. %, ≦about 45.0 wt. %, ≦about 50.0 wt. %, ≦about 55.0 wt. %, ≦about 60.0 wt. %, ≦about 65.0 wt. %, ≦about 70.0 wt. %, ≦about 75.0 wt. %, ≦about 80.0 wt. %, ≦about 85.0 wt. %, ≦about 90.0 wt. % or ≦about 95.0 wt. %. Ranges expressly disclosed include combinations of any of the above-enumerated values, e.g., about 1.0 wt. % to about 95.0 wt. %, about 2.0 wt. % to about 80.0 wt. %, about 10.0 wt. % to about 65.0 wt. %, about 14.0 wt. % to about 45 wt. %, about 5.0 wt. % to about 9.0 wt. %, etc.

Additionally or alternatively, a hydrocarbon portion of the reactor effluent may comprise one or more paraffins, e.g. having 1 to 20 carbon atoms, particularly 1 to 12 carbons atoms and particularly, 1 to 8 carbon atoms. The one or more paraffins may be present in a hydrocarbon portion of the reactor effluent in an amount of ≧about 1.0 wt. %, ≧about 5.0 wt. %, ≧about 10.0 wt. %, ≧about 15.0 wt. %, ≧about 20.0 wt. %, ≧about 25.0 wt. %, ≧about 30.0 wt. %, ≧about 35.0 wt. %, ≧about 40.0 wt. %, ≧about 45.0 wt. %, ≧about 50.0 wt. %, ≧about 55.0 wt. %, ≧about 60.0 wt. %, ≧about 65.0 wt. %, or ≧about 70.0 wt. %. Additionally or alternatively, the one or more paraffins may be present in a hydrocarbon portion of the reactor effluent in an amount of ≦about 1.0 wt. %, ≦about 5.0 wt. %, ≦about 10.0 wt. %, ≦about 15.0 wt. %, ≦about 20.0 wt. %, ≦about 25.0 wt. %, ≦about 30.0 wt. %, ≦about 35.0 wt. %, ≦about 40.0 wt. %, ≦about 45.0 wt. %, ≦about 50.0 wt. %, ≦about 55.0 wt. %, ≦about 60.0 wt. %, ≦about 65.0 wt. %, or ≦about 70.0 wt. %. Ranges expressly disclosed include combinations of any of the above-enumerated values, e.g., about 1.0 wt. % to about 70.0 wt. %, about 10.0 wt. % to about 55.0 wt. %, about 15.0 wt. % to about 60.0 wt. %, about 25.0 wt. % to about 65.0 wt. %, etc.

Additionally or alternatively, a hydrocarbon portion of the reactor effluent may comprise one or more aromatics, e.g., having 6 to 20 carbon atoms, particularly 12 to 20 carbons, particularly 6 to 18 carbon atoms, particularly 6 to 12 carbon atoms. The one or more aromatics may be present in a hydrocarbon portion of the reactor effluent in an amount of about ≧about 1.0 wt. %, ≧about 5.0 wt. %, ≧about 10.0 wt. %, ≧about 15.0 wt. %, ≧about 20.0 wt. %, ≧about 25.0 wt. %, ≧about 30.0 wt. %, ≧about 35.0 wt. %, ≧about 40.0 wt. %, ≧about 45.0 wt. %, ≧about 50.0 wt. %, ≧about 55.0 wt. %, ≧about 60.0 wt. %, or ≧about 65.0 wt. %. Additionally or alternatively, the one or more aromatics may be present in a hydrocarbon portion of the reactor effluent in an amount of ≦about 1.0 wt. %, ≦about 5.0 wt. %, ≦about 10.0 wt. %, ≦about 15.0 wt. %, ≦about 20.0 wt. %, ≦about 25.0 wt. %, ≦about 30.0 wt. %, ≦about 35.0 wt. %, ≦about 40.0 wt. %, ≦about 45.0 wt. %, ≦about 50.0 wt. %, ≦about 55.0 wt. %, ≦about 60.0 wt. %, or ≦about 65.0 wt. %. Ranges expressly disclosed include combinations of any of the above-enumerated values, e.g., about 1.0 wt. % to about 65.0 wt. %, about 10.0 wt. % to about 50.0 wt. %, about 15.0 wt. % to about 60.0 wt. %, about 25.0 wt. % to about 40.0 wt. %, etc.

In particular, C₁₂₊ aromatics may be present in a hydrocarbon portion of the reactor effluent in an amount of ≦about 0.1 wt. %, ≦about 0.2 wt. %, ≦about 0.3 wt. %, ≦about 0.4 wt. %, ≦about 0.5 wt. %, ≦about 0.6 wt. %, ≦about 0.7 wt. %, ≦about 0.8 wt. %, ≦about 0.9 wt. %, ≦about 1.0 wt. %, ≦about 2.0 wt. %, ≦about 3.0 wt. %, ≦about 4.0 wt. % or ≦about 5.0 wt. %. Particularly, C₁₂₊ aromatics are present in a hydrocarbon portion of the reactor effluent in an amount of ≦about 0.5 wt. %. Additionally or alternatively, C₁₂₊ aromatics may be present in a hydrocarbon portion of the reactor effluent in an amount of ≧about 0.1 wt. %, ≧about 0.2 wt. %, ≧about 0.3 wt. %, ≧about 0.4 wt. %, ≧about 0.5 wt. %, ≧about 0.6 wt. %, ≧about 0.7 wt. %, ≧about 0.8 wt. %, ≧about 0.9 wt. %, ≧about 1.0 wt. %, ≧about 2.0 wt. %, ≧about 3.0 wt. %, ≧about 4.0 wt. % or ≧about 5.0 wt. %. Ranges of amounts expressly disclosed include combinations of any of the above-enumerated values, e.g., about 0.1 to about 5.0 wt. %, about 0.1 to 0.5 wt. %, about 0.1 to about 0.3 wt. %, about 0.1 to about 2.0 wt. %, etc.

For example, the one or more aromatics may comprise benzene. Particularly, benzene may be present in a hydrocarbon portion of the reactor effluent in an amount of ≧about 1.0 wt. %, ≧about 2.0 wt. %, ≧about 3.0 wt. %, ≧about 4.0 wt. %, ≧about 5.0 wt. %, ≧about 6.0 wt. %, ≧about 7.0 wt. %, ≧about 8.0 wt. %, ≧about 9.0 wt. %, ≧about 10.0 wt. %, ≧about 12.0 wt. %, ≧about 14.0 wt. %, ≧about 16.0 wt. %, ≧about 18.0 wt. %, or ≧about 20.0 wt. %. Particularly, benzene is present in a hydrocarbon portion of the reactor effluent in an amount of ≧about 4.0 wt. %. Additionally or alternatively, benzene may be present in a hydrocarbon portion of the reactor effluent in an amount of ≦about 1.0 wt. %, ≦about 2.0 wt. %, ≦about 3.0 wt. %, ≦about 4.0 wt. %, ≦about 5.0 wt. %, ≦about 6.0 wt. %, ≦about 7.0 wt. %, ≦about 8.0 wt. %, ≦about 9.0 wt. %, ≦about 10.0 wt. %, ≦about 12.0 wt. %, ≦about 14.0 wt. %, ≦about 16.0 wt. %, ≦about 18.0 wt. %, or ≦about 20.0 wt. %. Ranges of amounts expressly disclosed include combinations of any of the above-enumerated values, e.g., about 1.0 to about 20.0 wt. %, about 2.0 to 12.0 wt. %, about 3.0 to about 6.0 wt. %, about 4.0 to about 8.0 wt. %, etc.

Additionally or alternatively, a hydrocarbon portion of the reactor effluent comprises a relatively small amount of durene. For example, the amount of durene present in a hydrocarbon portion of the reactor effluent may be ≦about 10.0 wt. %, ≦about 9.0 wt. %, ≦about 8.0 wt. %, ≦about 7.5 wt. %, ≦about 7.0 wt. %, ≦about 6.5 wt. %, ≦about 6.0 wt. %, ≦about 5.5 wt. %, ≦about 5.0 wt. %, ≦about 4.5 wt. %, ≦about 4.0 wt. %, ≦about 3.5 wt. %, ≦about 3.0 wt. %, ≦about 2.5 wt. %, ≦about 2.0 wt. %, ≦about 1.5 wt. %, ≦about 1.0 wt. %, ≦about 0.5 wt. % or about 0.0 wt. %. Particularly, the amount of durene present in a hydrocarbon portion the reactor effluent is ≦about 8.0 wt. %≦about 5.0 wt. % or ≦about 2.5 wt. %. Ranges of amounts expressly disclosed include combinations of any of the above-enumerated values, e.g., about 0.0 to about 8.0 wt. %, about 0.0 to about 5.0 wt. %, about 0.0 to about 3.0 wt. %, about 0.5 to about 2.5 wt. %, etc.

### D. Catalyst

The reactor comprises a catalyst for promoting conversion of the oxygenate feedstock (e.g., methanol) to a hydrocarbon product (e.g., C₅₊ gasoline product, benzene, etc.).

Typically, the catalyst comprises at least one molecular sieve material, which may have a framework type selected from the following group of framework types: ABW, ACO, AEI, AEL, AEN, AET, AFG, AFI, AFN, AFO, AFR, AFS, AFT, AFX, AFY, AHT, ANA, APC, APD, AST, ASV, ATN, ATO, ATS, ATT, ATV, AWO, AWW, BCT, BEA, BEC, BIK, BOG, BPH, BRE, CAG, CAN, CAS, CDO, CFI, CGF, CGS, CHA, CHI, CLO, CON, CRB, CZP, DAC, DDR, DFO, DFT, DIA, DOH, DON, EAB, EDI, EMT, EON, EPI, EM, ESV, ETR, EUO, EZT, FAR, FAU, FER, FRA, FRL, GIS, GIU, GME, GON, GOO, HEU, IFR, THW, ISV, ITE, ITH, ITW, TWR, IWV, IWW, JBW, KFI, LAU, LCS, LEV, LIO, LIT, LOS, LOV, LTA, LTL, LTN, MAR, MAZ, MEI, MEL, MEP, MER, MFI, MFS, MON, MOR, MOZ, MSE, MSO, MTF, MTN, MTT, MTW, MWW, NAB, NAT, NES, NON, NPO, NSI, OBW, OFF, OSI, OSO, OWE, PAR, PAU, PHI, PON, POZ, RHO, RON, RRO, RSN, RTE, RTH, RUT, RWR, RWY, SAO, SAS, SAT, SAV, SBE, SBS, SBT, SFE, SFF, SFG, SFH, SFN, SFO, SGT, SIV, SOD, SOS, SSY, STF, STI, STT, SZR, TER, THO, TON, TSC, TUN, UEI, UFI, UOZ, USI, UTL, VET, VFI, VNI, VSV, WEI, WEN, YUG, ZNI, and ZON. Particular examples of these framework types can include AEL, AFO, AHT, ATO, CAN, EUO, FER, HEU, IMF, ITH, LAU, MEL, MFI, MRE, MSE, MTT, NES, OBW, OSI, PON, RRO, SFF, SFG, STF, STI, SZR, TON, TUN and VET.

A suitable molecular sieve material may be a zeolite with the above-mentioned framework type. Generally, the zeolite employed in the present catalyst composition can typically have a silica to alumina molar ratio of at least 20, e.g., from about 20 to about 200. Suitable zeolites can include, but are not necessarily limited to, ZSM-5, ZSM-11, ZSM-12, ZSM-22, ZSM-23, ZSM-35, ZSM-48, ZSM-50, ZSM-57 and the like, as well as intergrowths and combinations thereof. In certain embodiments, the zeolite can comprise, consist essentially of, or be ZSM-5.

Additionally or alternatively, the zeolite may be present at least partly in hydrogen form in the catalyst (e.g., HZSM-5). Depending on the conditions used to synthesize the zeolite, this may implicate converting the zeolite from, for example, the alkali (e.g., sodium) form. This can readily be achieved, e.g., by ion exchange to convert the zeolite to the ammonium form, followed by calcination in air or an inert atmosphere at a temperature from about 400° C. to about 700° C. to convert the ammonium form to the active hydrogen form. If an organic structure directing agent is used in the synthesis of the zeolite, additional calcination may be desirable to remove the organic structure directing agent.

Additionally or alternatively, the molecular sieve material may be an aluminophosphate (i.e., ALPO). Suitable ALPOs can include, but are not necessarily limited to AlPO-11, AlPO-H2, AlPO-31 and AlPO-41.

Additionally or alternatively, the molecular sieve material may be a silicoaluminophosphate (i.e., SAPO). Suitable SAPOs can include, but are not necessarily limited to SAPO-11, SAPO-41, and SAPO-31.

Further additional suitable molecular sieves may include, but are not necessarily limited to GeAPO-11, MnAPO-11, MnAPO-41, MnAPSO-41, MAPO-31 (M=Mn, Ni, Zn, Mg, Co, Cr, Cu, Cd), VAPO-31, cancrinite (e.g., basic, hydrate, synthetics), [Al—Ge—O]-CAN, [Co—P—O]-CAN, [Ga—Ge—O]-CAN, [Ga—Si—O]-CAN, [Zn—P-0]-CAN, [Li—Cs][Al—Si—O]-CAN, [Li—Tl][Al—Si—O]-CAN, davyne, ECR-5, microsommite, tiptopite, vishnevite, EU-1, [B—Si—O]-EUO, TPZ-3, o-FDBDM-ZSM-50, ferrierite, [B—Si—O]-FER, [Ga—Si—O]-FER, [Si—O]-FER, FU-9, SIS-6, monoclinic ferrierite, NU-23, Sr-D, heulandite, clinoptilolite, dehyd. Ca,NH₄-heulandite, heulandite-Ba, LZ-219, IM-5, ITQ-13, Al-ITQ-13, IM-7, laumontite, [Co—Ga—P—O]-LAU, [Fe—Ga—P—O]-LAU, [Mn—Ga—P—O]-LAU, [Zn—Al—As—O]-LAU, [Zn—Ga—P—O]-LAU, leonhardite, Na,K-rich laumontite, primary leonhardite, synthetic laumontite, [DEOTA][Si—B—O]-MEL, Bor-D, boralite-D, SSZ-46, Silicate 2, TS-2, [As—Si—O]-MFI, [Fe—Si—O]-MFI, [Ga—Si—O]-MFI, AMS-1B, AZ-1, Bor-C, boralite, encilite, FZ-1, FeS-1, LZ-105, MnS-1, monoclinic H-ZSM-5, mutinaite, NU-4, NU-5, Silicalite, TS-1, TSZ, TSZ-II,TZ-01, USC-4, USI-108, ZBH, ZKQ-1B, ZMQ-TB, organic-free ZSM-5, MCM-68, EU-13, ISI-4, KZ-1, NU-87, gottardiite, OSB-2, UiO-6, IST-1, RUB-41, SSZ-44, STF-SFF intermediates, SSZ-58, SSZ-35, ITQ-9, Mu-26, stilbite (non-synthetic and synthetic), barrerite (non-synthetic and synthetic), stellerite (non-synthetic and synthetic), TNU-10, SUZ-4, Theta-1, ISI-1, KZ-2, NU-10, TNU-9, Mu-18, UZM-5, IM-10, IM-6, IM-12, ITQ-15 and VPI-8. A person of ordinary skill in the art knows how to make the aforementioned frameworks and molecular sieves. For example, see the references provided in the International Zeolite Association's database of zeolite structures found at www.iza-structure.org/databases.

The catalysts described herein can include and/or be enhanced by a transition metal. Catalyst compositions herein can include a Group 10-12 element or combinations thereof, of the Periodic Table. Exemplary Group 10 elements include, e.g., nickel, palladium, and/or platinum, particularly nickel. Exemplary Group 11 elements include, e.g., copper, silver, and/or gold, particularly copper. Exemplary Group 12 elements include e.g., zinc and/or cadmium. Preferably the transition metal is a Group 12 metal from the UPAC periodic table (sometimes designated as Group IIB) such as Zn and/or Cd. In particular embodiments, nickel, copper and/or zinc, particularly zinc, may be used. The Group 10-12 element can be incorporated into the catalyst by any convenient method, such as by impregnation or by ion exchange. After impregnation or ion exchange, the Group 10-12 element-enhanced catalyst can be treated in an oxidizing environment (air) or an inert atmosphere at a temperature of about 400° C. to about 700° C.

The amount of Group 10-12 element can be related to the molar amount of aluminum present in the catalyst (e.g., zeolite). Preferably, the molar ratio of the Group 10-12 element to aluminum in the catalyst can be about 0.1 to about 1.3. For example, the molar ratio of the Group 10-12 element to aluminum in the catalyst can be about ≧0.1, e.g., ≧about 0.2, ≧about 0.3, or ≧about 0.4. Additionally or alternately, the molar ratio of the Group 10-12 element to aluminum in the catalyst can be about ≦1.3, such as about ≦1.2, ≦about 1.0, or ≦about 0.8. In any embodiment, the ratio of the Group 10-12 element to aluminum is about 0.2 to about 1.2, about 0.3 to about 1.0, or about 0.4 to about 0.8. Still further additionally or alternately, the amount of Group 10-12 element can be expressed as a weight percentage of the catalyst, such as having ≧about 0.1 wt. %, ≧about 0.25 wt. %, ≧about 0.5 wt. %, ≧about 0.75 wt. %, or ≧about 1.0 wt. % of Group 10-12 element. Additionally or alternatively, the amount of Group 10-12 element can be present in an amount of ≦about 20 wt. %, such as ≦about 10 wt. %, ≦about 5 wt. %, ≦about 2.0 wt. %, ≦about 1.5 wt. %, ≦about 1.2 wt. %, ≦about 1.1 wt. %, or ≦about 1.0 wt. %. In any embodiment, the amount of Group 10-12 element may be about 0.25 to about 10.0 wt. %, about 0.5 to about 5.0 wt. %, about 0.75 to about 2.0 wt. %, or about 1.0 to about 1.5 wt. %, based on the total weight of the catalyst composition excluding the weight of any binder if present.

Additionally or alternatively, the catalyst described herein may also include at least one Group 2 and/or a Group 3 element. As used herein the term “Group 3” is intended to include elements in the Lanthanide series of the Periodic Table. In any embodiment, one or more Group 2 elements (e.g., Be, Mg, Ca, Sr, Ba and Ra) may be used. In other embodiments, one or Group 3 element (e.g., Sc and Y), a Lanthanide (e.g., La, Ce, Pr, Nd, Sm, Eu, Gd, Tb, Dy, Ho, Er, Tm, Yb and Lu). Actinides (e.g., Ac, Th, Pa, U, Np, Pu, Am, Cm, Bk, Cf, Es, Fm, Md, No, Lr) may be used as well. When present, the total weight of the at least one Group 2 and/or Group 3 elements is from about 0.1 to about 20.0 wt. %, based on the total weight of the catalyst composition excluding the weight of any binder if present. In any embodiment, the amount of the at least one Group 2 and/or a Group 3 element may be about 0.25 to about 10.0 wt. %, about 0.5 to about 5.0 wt. %, about 0.75 to about 2.0 wt. %, or about 1.0 to about 1.5 wt. %. The presence of Group 2 and/or Group 3 element is believed to reduce coke formation.

Additionally or alternatively, the catalyst described herein can contain phosphorus. The phosphorus can be added to the catalyst composition at any stage during synthesis of the catalyst and/or formulation of the catalyst and binder into the catalyst composition. Generally, phosphorus addition can be achieved by spraying and/or impregnating the final catalyst composition (and/or a precursor thereto) with a solution of a phosphorus compound, which may be followed by calcining the catalyst.

Catalyst Binder

The catalysts described herein can optionally be employed in combination with a support or binder material (binder). The binder is preferably an inert, non-alumina containing material, such as a porous inorganic oxide support or a clay binder. One such preferred inorganic oxide is silica. Other examples of such binder material include, but are not limited to zirconia, magnesia, titania, thoria and boria. These materials can be utilized in the form of a dried inorganic oxide gel or as a gelatinous precipitate. Suitable examples of clay binder materials include, but are not limited to, bentonite and kieselguhr. The relative proportion of catalyst to binder material to be utilized is from about 30.0 wt. % to about 98.0 wt. %. A proportion of catalyst to binder from about 50.0 wt. % to about 80.0 wt. % is more preferred. The bound catalyst can be in the form of an extrudate, beads or fluidizable microspheres.

### Catalyst Selectivation

The catalyst of the present invention may be selectivated. As used herein, the term “selectivated” refers to a catalyst wherein the dimensions of the pore/channel of the catalyst have been modified (e.g., the catalyst pore size has been reduced) to be more selective toward desirable products. Further, as used herein, “selectivated” and/or “selectivation” is understood as different and separate from “activation” of the catalyst. Thus, processes for activating a catalyst (e.g., base exchange, alumina extraction, calcination, ammonium impregnation, cation impregnation, etc.) are not necessarily included in catalyst selectivation processes. Exemplary methods of preparing a selectivated catalyst include, but are not limited to, treatment or impregnation of the catalyst with a selectivating agent (e.g., a silicon containing compound, a phosphorous containing compound, magnesium oxide, calcium oxide, boric acid etc.) and steaming of the catalyst. Typically, the catalyst is selectivated during formation of the catalyst and/or prior to inclusion of a binder with the catalyst. Thus, it is the catalyst which is selectivated and not only the binder which is selectivated. Additionally or alternatively, the catalyst may be combined with a binder and then the catalyst may be selectivated. Additionally or alternatively, once the catalyst is selectivated, the binder may then be selectivated.

As used herein, the term “selectivating agent” is used to indicate substances which will increase the shape-selectivity of a catalytic molecular sieve to the desired levels while maintaining commercially acceptable levels of hydrocarbon conversion.

The catalyst may be ex situ selectivated by single or multiple treatments with a selectivating agent. Each treatment can be followed by calcination of the treated material in an oxygen-containing atmosphere, e.g., air.

### Silicon Selectivation

Typically, the selectivating agent may be in the form of a solution, an emulsion, a liquid or a gas under the conditions of contact with the catalyst. Particularly, the selectivating agent is preferably contacted with the catalyst as a liquid, more preferably as a solution including a silicon-containing selectivating agent dissolved in an organic carrier. The catalyst may be contacted at least one, two, three, four, five, six, seven or eight times with the selectivating agent dissolved in an organic solvent/carrier, preferably between about two and about six times.

In accordance with the multiple impregnation ex situ selectivation method, the catalyst is treated at least twice, e.g., from 2 to 6 times, with a liquid medium comprising a liquid carrier and at least one liquid silicon-containing selectivating agent. The silicon-containing compound may be present in the form of a solute dissolved in the liquid carrier or in the form of emulsified droplets in the liquid carrier. For the purposes of the present disclosure, it will be understood that a normally solid silicon compound will be considered to be a liquid (i.e., in the liquid state) when it is dissolved or emulsified in a liquid medium. The liquid carrier may be water, an organic liquid or a combination of water and an organic liquid. Particularly when the liquid medium comprises an emulsion of the silicon-containing compound in water, the liquid medium may also comprise an emulsifying agent, such as a surfactant. Stable aqueous emulsions of silicon-containing compounds (e.g., silicone oil) suitable for use in the present invention are described in U.S. Pat. No. 5,726,114. These emulsions are generated by mixing the silicon oil and an aqueous component in the presence of a surfactant or surfactant mixture. Useful surfactants include any of a large variety of surfactants, including ionic and non-ionic surfactants. Particular surfactants include non-nitrogenous, non-ionic surfactants such as alcohol, alkylphenol, and polyalkoxyalkanol derivatives, glycerol esters, polyoxyethylene esters, anhydrosorbitol esters, ethoxylated anhydrosorbitol esters, natural fats, oils, waxes and ethoxylated esters thereof, glycol esters, polyalkylene oxide block co-polymer surfactants, poly(oxyethylene-co-oxypropylene) non-ionic surfactants, and mixtures thereof. Further particular surfactants include octoxynols such as Octoxynol-9. Such surfactants include the TRITON® X series, such as TRITON® X-100 and TRITON® X-305, available from Rohm & Haas Co., Philadelphia, Pa., and the Igepal® Calif series from GAF Corp., New York, N.Y. Silicon-containing compounds useful herein are water soluble and may be described as organopolysiloxanes.

The silicon-containing selectivating agent may be, for example, a silicone, polysiloxane, a siloxane, a silane, a disilane, an alkoxysilane and mixtures thereof. These silicon-containing compounds may have at least 2 silicon atoms per molecule. These silicon-containing compounds may be solids in pure form, provided that they are soluble or otherwise convertible to the liquid form upon combination with the liquid carrier medium. The molecular weight of the silicone, siloxane or silane compound employed as a selectivating agent may be between about 80 and about 20,000, and preferably within the approximate range of about 150 to about 10,000.

Useful selectivating agents include silicones and silicone polymers which can be characterized by the general formula:

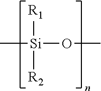

wherein R₁ and R₂ are independently selected from among hydrogen, halogen, hydroxyl, alkyl, halogenated alkyl, aryl, halogenated aryl, aralkyl, halogenated aralkyl, alkaryl or halogenated alkaryl. The hydrocarbon substituents generally contain from 1 to 10 carbon atoms, preferably methyl or ethyl groups. Also in the general formula, n is an integer of at least 2 and generally in the range of 3 to 1000. Representative silicon-containing compounds include dimethyl silicone, diethyl silicone, phenylmethyl silicone, methylhydrogen silicone, ethylhydrogen silicone, phenylhydrogen silicone, methylethyl silicone, phenylethylsilicone, diphenyl silicone, methyltrifluoropropyl silicone, ethyltrifluoropropyl silicone, polydimethyl silicone, tetrachlorophenylmethyl silicone, tetrachlorophenylethyl silicone, tetrachlorophenylhydrogen silicone, tetrachlorophenyl silicone, methylvinyl silicone, and ethylvinyl silicone. The ex situ selectivating silicone, siloxane or silane compound need not be linear, but may be cyclic, for example, hexamethyl cyclotrisiloxane, octamethyl cyclotetrasiloxane, hexaphenyl cyclotrisiloxane and octaphenyl cyclotetrasiloxane. Mixtures of these compounds may also be used as liquid ex situ selectivating agents, as may silicones with other functional groups.

Other silicon-containing compounds, including silanes and alkoxysilanes, such as tetramethoxy silane, may also be utilized. These useful silicon-containing selectivating agents include silanes and alkoxysilanes characterizable by the general formula:

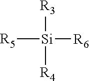

where R₃, R₄, R₅ and R₆ are independently selected from the group consisting of hydrogen, hydroxyl, halogen, alkyl, halogenated alkyl, alkoxy, aryl, halogenated aryl, aralkyl, halogenated aralkyl, alkaryl, and halogenated alkaryl groups. Mixtures of these compounds may also be used.

Particular silicon-containing selectivating agents, particularly when the ex situ selectivating agent is dissolved in an organic carrier or emulsified in an aqueous carrier, include dimethylphenylmethylpolysiloxane (e.g., Dow-550®) and phenylmethyl polysiloxane (e.g., Dow-710®). Dow-550® and Dow-710® are available from Dow Chemical Company, Midland, Mich.

Water soluble silicon-containing compounds are commercially available as, for example, SAG-5300®, manufactured by Union Carbide, Danbury Conn., conventionally used as an anti-foam, and SF 1188® manufactured by General Electric, Pittsfield, Mass.

When the silicon-containing selectivating agent is present in the form of a water soluble compound in an aqueous solution, the silicon-containing compound may be substituted with one or more hydrophilic functional groups or moieties, which serve to promote the overall water solubility of the silicon-containing compound. These hydrophilic functional groups may include one or more organoamine groups, such as —N(CH₃)₃, —N(C₂H₅)₃, and —N(C₃H₇)₃. A preferred water soluble silicon-containing selectivating agent is an n-propylamine silane, available as Hydrosil 2627® from Creanova (formerly Huls America), Somerset, N.J.

The silicon-containing compound can be preferably dissolved in an aqueous solution in an silicon-containing compound/H₂O weight ratio of from about 1/100 to about 1/1.

A “solution” is intended to mean a uniformly dispersed mixture of one or more substances at the molecular or ionic level. The skilled artisan will recognize that solutions, both ideal and colloidal, differ from emulsions.

The catalyst can be contacted with a substantially aqueous solution of the silicon-containing compound at a catalyst/silicon-containing compound weight ratio of from about 100/1 to about 1/100, at a temperature of about 10° C. to about 150° C., at a pressure of about 0 psig (about 0 kPa) to about 200 psig (about 1375 kPa), for a time of about 0.1 hour to about 24 hours, the water may be removed, e.g., by distillation, or evaporation with or without vacuum, and the catalyst is calcined.

Selectivation is carried out on the catalyst, e.g., by conventional ex situ treatments of the catalyst before loading into a hydrocarbon conversion reactor. Multiple ex situ treatments, e.g., 2 to 6 treatments, particularly 2 to 4 treatments, have been found especially useful to selectivate the catalyst. When the catalyst is ex situ selectivated by a single or multiple impregnation technique, the catalyst can be calcined after each impregnation to remove the carrier and to convert the liquid silicon-containing compound to a solid residue material thereof. This solid residue material is referred to herein as a siliceous solid material, insofar as this material is believed to be a polymeric species having a high content of silicon atoms in the various structures thereof.

Following each impregnation, the catalyst may be calcined at a rate of from about 0.2° C./minute to about 50° C./minute to a temperature greater than 200° C., but below the temperature at which the crystallinity of the catalyst is adversely affected. This conventional calcination temperature is below 1200° C., e.g., within the approximate range of ˜350° C. to ˜1100° C. The duration of calcination at the calcination temperature may be from ˜1 to ˜24 hours, e.g., from ˜2 to ˜6 hours.

The calcination process may be performed in an inert or oxidizing atmosphere. An example of such an inert atmosphere is a nitrogen, i.e., N₂, atmosphere. An example of an oxidizing atmosphere is an oxygen containing atmosphere, such as air. Calcination may take place initially in an inert, e.g., N₂, atmosphere, followed by calcination in an oxygen containing atmosphere, such as air or a mixture of air and N₂. Calcination should be performed in an atmosphere substantially free of water vapor to avoid undesirable uncontrolled steaming of the zeolite. The catalyst may be calcined once or more than once following each impregnation. The various conventional calcinations following each impregnation need not be identical, but may vary with respect to the temperature, the rate of temperature rise, the atmosphere and the duration of calcination.

The amount of siliceous residue material which is deposited on the catalyst is dependent upon a number of factors including the temperatures of the impregnation and calcination steps, the concentration of the silicon-containing compound in the carrying medium, the degree to which the catalyst has been dried prior to contact with the silicon-containing compound, the atmosphere used in the calcination and duration of the calcination.

High Temperature Calcination

Subsequent to the selectivating procedure(s) and any conventional calcination associated therewith, the selectivated catalyst of the present invention may be further subjected to a severe, high temperature, calcination treatment. Crystallinity can be measured by hexane uptake (percent crystallinity for hexane uptake calculated as hexane uptake of sample divided by hexane uptake of uncalcined sample). Crystallinity can also be measured by X-ray diffraction.

The high temperature calcining step can be carried out under conditions sufficient to provide a catalyst having an alpha value of less than 700, preferably less than 250, say, from 75 to 150, or 5 to 25, depending on the catalyst application, a crystallinity as measured by X-ray diffraction of no less than 85%, preferably no less than 95%, and a diffusion barrier of the catalytic molecular sieve as measured by the rate of 2,3-dimethylbutane or 2,2-dimethylbutane uptake of less than 270, preferably less than 150 (D/(r²×10⁶ sec)).

The high temperature calcining step can be carried out at temperatures ranging from greater than about 700° C. to about 1200° C. for about 0.1 to about 12 hours, e.g., from about 750° C. to about 1000° C. for about 0.3 to about 2 hours, preferably from about 750° C. to about 1000° C. for about 0.5 to about 1 hours.

The selectivated catalyst may be high temperature calcined in an inert atmosphere, an oxidizing atmosphere, or a mixture of both. An example of such an inert atmosphere is nitrogen, i.e., N₂. An example of an oxidizing atmosphere is an oxygen containing atmosphere, such as air. Alternatively, calcination may take place initially in an inert, e.g., N₂, atmosphere, followed by calcination in an oxygen containing atmosphere, such as air or a mixture of air and N₂, or vice versa. Calcination should be performed in an atmosphere substantially free of water vapor to avoid undesirable uncontrolled steaming of the zeolite. Thus, the high temperature calcining step is preferably carried out in the absence of intentionally added steam.

Phosphorus Selectivation

During phosporus selectivation, the catalyst may be impregnated with a phosphorus-containing compound, such as phosphoric acid to achieve a level of at least ˜10.0 wt. % phosphorus, at least ˜15.0 wt. % phosphorus or at least ˜20.0 wt. % phosphours. Impregnation with the phosphorus-containing compound may be achieved via aqueous incipient wetness impregnation. Once the catalyst is impregnated with phosphorus, it may be dried and then it may be calcined for ˜2 to ˜4 hours, particularly ˜3 hours, at ˜500° C. to ˜800° C., particularly at least about ˜500° C., to form a phosphorus selectivated catalyst.

Steam Selectivation

During steam selectivation, the catalyst may be calcined for ˜2 to ˜4 hours, particularly ˜3 hours, at ˜500° C. to ˜800° C., particularly at least about ˜500° C., which may remove any volatile materials form the catalyst. The catalyst may then be subjected to steam at ˜600° C. to ˜1200° C., preferably at least about ˜500° C., at ˜101 kPa for ˜3 to ˜5 hours, particularly ˜4 hours to form a steam selectivated catalyst.

In particular, the catalyst utilized in the processes and systems described herein is selected from the group consisting of a selectivated zeolite, a SAPO, a selectivated SAPO, an ALPO and a selectivated ALPO. The selectivated zeolite, the selectivated SAPO, and the selectivated ALPO may each independently be steam selectivated, silicon selectivated and/or phosphorous selectivated. The selectivated SAPO may be selected from the group consisting of selectivated SAPO-11, selectivated SAPO-41 and selectivated SAPO-31. The selectivated ALPO may be selected from the group consisting of selectivated ALPO-11, selectivated ALPO-H2, selectivated ALPO-41 and selectivated ALPO-31.

In particular, the catalyst is a selectivated zeolite selected from the group consisting of selectivated ZSM-5, selectivated ZSM-11, selectivated ZSM-12, selectivated ZSM-22, selectivated ZSM-23, selectivated ZSM-35, selectivated ZSM-48, selectivated ZSM-50, selectivated ZSM-57, and selectivated intergrowths and combinations thereof. Particularly, the selectivated catalyst is a silicone selectivated zeolite (e.g., silicon selectivated ZSM-5).

In various aspects, a process for converting an oxygenate feedstock to a hydrocarbon product is provided. The process comprises feeding the oxygenate feedstock to a reactor under conditions to convert at least a portion of the oxygenate feedstock to a hydrocarbon product in a reactor effluent, wherein the reactor comprises a catalyst selected from the group consisting of a selectivated zeolite, a selectivated SAPO and a selectivated ALPO, and wherein a hydrocarbon portion of the reactor effluent comprises less than about 8.0 wt. % durene and less than about 0.5 wt. % C₁₂₊ aromatics; and separating a C₅₊ gasoline product from the reactor effluent.

In various aspects, a silicon selectivated zeolite catalyst for oxygenate conversion to a hydrocarbon product is provided, wherein the hydrocarbon product produced during the oxygenate conversion has a durene content of less than about 2.5 wt. % and a benzene content of at least about 4 wt. %.

### E. Separation of Hydrocarbon

The process may further comprise separating various hydrocarbons in the reactor effluent, e.g., separating the C₅₊ gasoline product from the reactor effluent. Separation is distinct from further processes requiring reacting the hydrocarbons in the reactor effluent, such as but not limited to heavy gasoline treatment (HGT), alkylation, etc. Separation may be accomplished by any suitable separation means and combination thereof, e.g., distillation tower, simulated moving-bed separation unit, high pressure separator, low pressure separator, flash drum, etc. For example, C₂₋ light gas can be separated from C₃₊ product in the reactor effluent, in for example, a fractionating column (e.g., de-ethanizer) Additionally or alternatively, the C₃₊ product can be sent to a stabilizer (e.g., de-butanizer) where the C₃ and part of the C₄ hydrocarbon components can be removed from C₅₊ gasoline product.

### F. Further Processing

Additionally or alternatively, the de-ethanizer bottom product from the stabilizer can be fed into a gasoline splitter where it can be separated into light and heavy gasoline fractions. The heavy gasoline fraction, which may contain durene, can be passed to an HGT reactor for reduction of durance content. In the HGT process, the heavy MTG gasoline, comprising primarily aromatics, can be processed over a multifunctional metal acid catalyst. The following reactions can occur: disproportionation, isomerization, transalkylation, ring saturation, and dealkylation/cracking wherein durene content can be further reduced. Additionally or alternatively, a further step of treating the reactor effluent (e.g., HGT process) to reduce the durene content is not present.

Additionally or alternatively, the C₃ and of the C₄ hydrocarbon components (e.g., isobutene, propylene, and butenes) can be fed to an alkylation unit for conversion to C₅₊ gasoline product.

Additionally or alternatively, the reactor may also be connected to a regeneration system to regenerate spent catalyst. As used herein, “spent catalyst” refers to catalyst with coke material (e.g., carbonaceous material) absorbed thereon during the conversion reaction, which may lower the activity of the catalyst and/or lower the temperature of the catalyst. In the regeneration system, the coke material may be removed and/or burned off the spent catalyst for a suitable period of time to form regenerated catalysts. For example, in the regeneration system, the spent catalyst may be contacting with oxygen or an oxygen-containing gas.

In various aspects, a process for converting an oxygenate feedstock to a hydrocarbon product comprising: feeding the oxygenate feedstock to a reactor under conditions to convert at least a portion of the oxygenate feedstock to the hydrocarbon product in a reactor effluent, wherein the reactor comprises a silicon selectivated zeolite catalyst, and wherein the reactor effluent comprises less than about 2.5 wt. % durene prior to: (i) separating a C₅₊ gasoline product from the reactor effluent; and/or (ii) heavy gasoline treatment of the reactor effluent.

In various aspects, a methanol-to-gasoline (MTG) hydrocarbon product comprising a durene content of less than about 2.5 wt. % and a benzene content of at least about 4 wt. % at one or more of the following: a) prior to separating a C₅₊ gasoline product from the MTG hydrocarbon product; b) prior to heavy gasoline treatment of the MTG hydrocarbon product; and/or c) produced directly in an MTG reactor.

In various aspects, an MTG hydrocarbon product comprising a durene content of less than about 2.5 wt. % and a benzene content of at least about 4 wt. %, wherein the MTG hydrocarbon product is present in an MTG reactor.

### III. PROCESSES FOR REDUCING OFF-SPEC GASOLINE PRODUCTION

In another embodiment, a process for reducing off-spec gasoline production is provided, particularly, during start-up of the process. As used herein “start-up” refers to the start or initiation as well as the resumption following an interruption of the methanol-to-gasoline conversion process as opposed to steady-state operation. Start-up may comprise the time beginning from when the feedstock is first introduced into the reactor comprising fresh catalyst, with essentially no coke deposited thereon, and lasting an additional at least 2 hours, at least 4 hours, at least 6 hours, at least 8 hours, at least 10 hours, at least 12 hours, at least 18 hours, at least 24 hours, at least 36 hours, or at least 48 hours. Additionally or alternatively, start-up may comprise a period of time following resumption of the process after an interruption, such a pressure surge and/or a temperature overheating. As used herein, the term “off-spec gasoline” refers to a gasoline product comprising components having boiling points above 450° F. (e.g., C₁₂₊ aromatics), wherein the presence of those components may discolor the gasoline product.

The process may comprise at start-up feeding a feedstock comprising methanol to a reactor under conditions to convert at least a portion of the feedstock to a C₅₊ gasoline product in a reactor effluent, wherein the reactor comprises a silicon selectivated zeolite catalyst as described herein, and wherein a hydrocarbon portion of the reactor effluent comprises: less than about 2.5 wt. % durene; and less than about 0.5 wt. % C₁₂₊ aromatics.

### IV. SYSTEMS FOR CONVERTING AN OXYGENATE FEEDSTOCK TO A HYDROCARBON PRODUCT

In another embodiment, a system for converting an oxygenate feedstock to a hydrocarbon product is provided comprising a reactor as described above.

In the system, the reactor may comprise an oxygen feedstock stream as described above and an inlet for the oxygenate feedstock stream, a catalyst as described above; a reactor effluent stream as described above and an outlet for the reactor effluent stream. In particular, the reactor is a moving bed reactor, fixed bed reactor or a fluidized bed reactor, particularly, a fluidized bed reactor. The oxygenate feedstock stream may comprise methanol and/or dimethyl ether, optionally containing water. In particular, a hydrocarbon portion of the reactor effluent comprises less than about 8.0 wt. % durene, particularly less about 2.5 wt. % durene, less than 0.5 wt. % C₁₂₊ aromatics, and/or benzene, particularly at least about 4.0 wt. % benzene.

Particularly, the catalyst is selected from the group consisting of a selectivated zeolite (e.g., selectivated ZSM-5, selectivated ZSM-11, selectivated ZSM-12, selectivated ZSM-22, selectivated ZSM-23, selectivated ZSM-35, selectivated ZSM-48, selectivated ZSM-50, selectivated ZSM-57, selectivated intergrowths and combinations thereof), a SAPO (e.g., SAPO-11, SAPO-41, and SAPO-31), a selectivated SAPO, an ALPO (e.g., AlPO-11, AlPO-H2, AlPO-31 and AlPO-41), and a selectivated ALPO and/or the selectivated zeolite, the selectivated SAPO and the selectivated ALPO are each independently steam selectivated, silicon selectivated and/or phosphorous selectivated. In particular, the catalyst is a silicon selectivated zeolite (e.g., silicon selectivated zeolite).

Additionally or alternatively, the system further comprises a separation system in fluid connection with the reactor for separating the C₅₊ gasoline product from the reactor effluent stream comprising an inlet for the reactor effluent stream; a C₅₊ gasoline product stream; and an outlet for the C₅₊ gasoline product stream. The separation system may comprise any suitable separation means and combination thereof as described above, e.g., distillation tower, simulated moving-bed separation unit, high pressure separator, low pressure separator, flash drum, etc.

Additionally or alternatively, the system may further comprise a dehydration apparatus in fluid connection with the reactor for reducing water content in the oxygenate feedstock, e.g., for catalytic dehydration over e.g., γ-alumina, prior to introduction into the reactor. Additionally or alternatively, the dehydration apparatus for reducing water content in the oxygenate feedstock is not present in the system.

Additionally or alternatively, the system may further comprise a heavy gasoline treatment (HGT) reactor in fluid connection with the reactor for reduction of durene content in the reactor effluent. Additionally or alternatively, a reactor for reducing durene content is not present.

Additionally or alternatively, the system may further comprise an alkylation unit in fluid connection with the reactor for converting C₃ and C₄ hydrocarbon components (e.g., isobutene, propylene, and butenes) to C₅₊ gasoline product.

In various aspects, an MTG reactor is provided, wherein the MTG reactor comprises a silicone selectivated zeolite catalyst; and an MTG hydrocarbon product comprising a durene content of less than about 2.5 wt. % and a benzene content of at least about 4.0 wt. %.

### V. FURTHER EMBODIMENTS

### Embodiment 1

A process for converting an oxygenate feedstock to a hydrocarbon product comprising or consisting essentially of feeding the oxygenate feedstock comprising, e.g., methanol and/or dimethyl ether, optionally containing water, to a reactor under conditions to convert at least a portion of the oxygenate feedstock to the hydrocarbon product in a reactor effluent, wherein the reactor comprises a catalyst selected from the group consisting of a selectivated zeolite, a SAPO, a selectivated SAPO, an ALPO and a selectivated ALPO, and wherein a hydrocarbon portion of the reactor effluent comprises less than about 8.0 wt. % durene, particularly less than about 2.5 wt. % durene, less than about 0.5 wt. % C₁₂₊ aromatics, and/or benzene, particularly at least about 4.0 wt. % benzene; separating a C₅₊ gasoline product from the reactor effluent; optionally, wherein a further step of treating the reactor effluent to reduce the durene content is not present; and optionally, wherein a further step of pre-treating the oxygenate feedstock to reduce water content is not present.

### Embodiment 2

A process for converting an oxygenate feedstock to a hydrocarbon product comprising feeding the oxygenate feedstock to a reactor under conditions to convert at least a portion of the oxygenate feedstock comprising, e.g., methanol and/or dimethyl ether, optionally containing water, to the hydrocarbon product in a reactor effluent, wherein the reactor comprises a catalyst (e.g., a selectivated zeolite, a SAPO, a selectivated SAPO, an ALPO, a selectivated ALPO), particularly a selectivated zeolite, and wherein a hydrocarbon portion of the reactor effluent comprises less than about 8.0 wt. % durene, particularly less than about 2.5 wt. % durene, less than about 0.5 wt. % C₁₂₊ aromatics, and/or benzene, particularly at least about 4.0 wt. % benzene prior to: (i) separating a C₅₊ gasoline product from the reactor effluent; and/or (ii) heavy gasoline treatment of the reactor effluent.

### Embodiment 3

A process for reducing off-spec gasoline production during start-up of an MTG conversion process comprising at start-up feeding a feedstock comprising methanol and/or or dimethyl ether, optionally containing water to a reactor under conditions to convert at least a portion of the feedstock to a C₅₊ gasoline product in a reactor effluent, wherein the reactor comprises a catalyst (e.g., a selectivated zeolite, a SAPO, a selectivated SAPO, an ALPO, a selectivated ALPO), particularly a selectivated zeolite, and wherein a hydrocarbon portion of the reactor effluent comprises: less than about 2.5 wt. % durene; and less than about 0.5 wt. % C₁₂₊ aromatics.

### Embodiment 4

The process of embodiment 1, 2, or 3, wherein the reactor is a moving bed reactor, a fixed bed reactor or a fluidized bed reactor, particularly a fluidized bed reactor.

### Embodiment 5

The process of embodiment 1, 2, 3 or 4, wherein the temperature in the reactor is about 550° F. to about 1000° F. and/or the pressure in the reactor is about 10 psig to about 500 psig.

### Embodiment 6

The process of embodiment 1, 2, 3, 4 or 5, wherein the selectivated zeolite, the selectivated SAPO and the selectivated ALPO are each independently steam selectivated, silicon selectivated and/or phosphorous selectivated.

### Embodiment 7

The process of embodiment 1, 2, 3, 4, 5, or 6, wherein the selectivated zeolite is selected from the group consisting of selectivated ZSM-5, selectivated ZSM-11, selectivated ZSM-12, selectivated ZSM-22, selectivated ZSM-23, selectivated ZSM-35, selectivated ZSM-48, selectivated ZSM-50, selectivated ZSM-57, and selectivated intergrowths and combinations thereof, particularly a silicon selectivated zeolite, such as silicon selectivated ZSM-5.

### Embodiment 8

The process of embodiment 1, 2, 3, 4, 5, 6 or 7, wherein the SAPO is selected from the group consisting of SAPO-11, SAPO-41, and SAPO-31 and/or the ALPO is selected from the group consisting of AlPO-11, AlPO-H2, AlPO-31 and AlPO-41.

### Embodiment 9

The process of embodiment 1, 2, 3, 4, 5, 6, 7 or 8, wherein at least 90% of the methanol is converted into the hydrocarbon product.

### Embodiment 10

A system for converting an oxygenate feedstock to a C₅₊ gasoline product comprising or consisting essentially of a reactor comprising: a oxygenate feedstock stream and an inlet for the oxygenate feedstock stream comprising, e.g., methanol and/or dimethyl ether, optionally containing water; a catalyst selected from the group consisting of a selectivated zeolite, a SAPO, a selectivated SAPO, an ALPO and a selectivated ALPO; a reactor effluent stream and an outlet for the reactor effluent, wherein a hydrocarbon portion of the reactor effluent comprises less than about 8.0 wt. % durene, particularly less than about 2.5 wt. % durene, less than about 0.5 wt. % C₁₂₊ aromatics, and/or benzene, particularly at least about 4.0 wt. % benzene; a separation system in fluid connection with the reactor for separating the C₅₊ gasoline product from the reactor effluent stream comprising: an inlet for the reactor effluent stream; a C₅₊ gasoline product stream and an outlet for the C₅₊ gasoline product stream; optionally, a reactor for reducing durene content is not present; and optionally, an apparatus for reducing water content in the oxygenate feedstock is not present.

### Embodiment 11

A catalyst (e.g., a selectivated zeolite, a SAPO, a selectivated SAPO, an ALPO, a selectivated ALPO), particularly a selectivated zeolite, for oxygenate conversion to a hydrocarbon product, wherein the hydrocarbon product (e.g., a C₅₊ gasoline product) produced during the oxygenate conversion has a durene content of less than about 8.0 wt. %, particularly less than about 2.5 wt. %, a benzene content of at least about 4 wt. %, and optionally a C₁₂₊ aromatics content of less than 0.5 wt. %.

### Embodiment 12

A hydrocarbon product, such as methanol-to-gasoline (MTG) hydrocarbon product, comprising a durene content of less than about 8.0 wt. %, particularly less than about 2.5 wt. % and a benzene content of at least about 4 wt. % at one or more of the following: a) prior to separating a C₅₊ gasoline product from the hydrocarbon product; b) prior to heavy gasoline treatment of the hydrocarbon product; and/or c) produced directly in a reactor (e.g., MTG reactor); and/or wherein the hydrocarbon product is present in the reactor.

### Embodiment 13

A reactor (e.g., MTG reactor) comprising: a catalyst (e.g., a selectivated zeolite, a SAPO, a selectivated SAPO, an ALPO, a selectivated ALPO), particularly a selectivated zeolite; and a hydrocarbon product, such as a MTG hydrocarbon product (e.g., a C₅₊ gasoline product), comprising a durene content of less than about 8.0 wt. %, particularly less than about 2.5 wt. % and a benzene content of at least about 4.0 wt. %

### Embodiment 14

The embodiment 10, 12 or 13, wherein the reactor is a moving bed reactor, a fixed bed reactor or a fluidized bed reactor, particularly a fluidized bed reactor.

### Embodiment 15

The embodiment 10, 11, 13 or 14, wherein the selectivated zeolite, the selectivated SAPO and the selectivated ALPO are each independently steam selectivated, silicon selectivated and/or phosphorous selectivated, particularly silicon selectivated.

### Embodiment 16

The embodiment 10, 11, 13, 14 or 15, wherein the selectivated zeolite is selected from the group consisting of selectivated ZSM-5, selectivated ZSM-11, selectivated ZSM-12, selectivated ZSM-22, selectivated ZSM-23, selectivated ZSM-35, selectivated ZSM-48, selectivated ZSM-50, selectivated ZSM-57, and selectivated intergrowths and combinations thereof, particularly a silicon selectivated zeolite, such as silicon selectivated ZSM-5

### Embodiment 17

The embodiment 10, 11, 13, 14, 15 or 16, wherein the SAPO is selected from the group consisting of SAPO-11, SAPO-41, and SAPO-31 and/or the ALPO is selected from the group consisting of AlPO-11, AlPO-H2, AlPO-31 and AlPO-41.

### EXAMPLES

The following examples are merely illustrative, and do not limit this disclosure in any way.

### Example 1—Methanol Conversion Using Silicon Selectivated Zeolite Catalyst Catalyst Preparation

Catalyst extrudates were prepared via silica binding of HZSM-5 having a SiO₂/Al₂O₃ ratio of about 26. Successive, silicon impregnations (i.e, two and three) were done to pore filling using ˜7.8 wt. % Dow Corning-550 fluid in decane to form two catalysts, silicon selectivated HZSM-5 (2×) (i.e., 2 silicon impregnations) and silicon selectivated HZSM-5 (3×) (i.e., 3 silicon impregnations). The decane solvent was stripped from the sample and the catalyst was calcined in nitrogen and then dry air at ˜1000° F.

### Catalyst Testing

A stainless-steel packed bed reactor heated by a single zone furnace was used for catalyst evaluation. Reactions were performed using ˜50 mg of catalyst mixed with ˜20 mg quartz sand. A ˜90:10 methanol/water mixture by volume was delivered to the reactor using a syringe pump. Experiments were conducted at ˜450° C., ˜15 psig, and ˜20 WHSV (g MeOH/g catalyst/hour). The reactor effluent was captured during a ˜6 hour run in heated sample loop and analyzed offline by a gas chromatograph equipped with a flame ionization detector. Light gases (H₂, CO, CO₂) and water in the reactor effluent were not quantified.

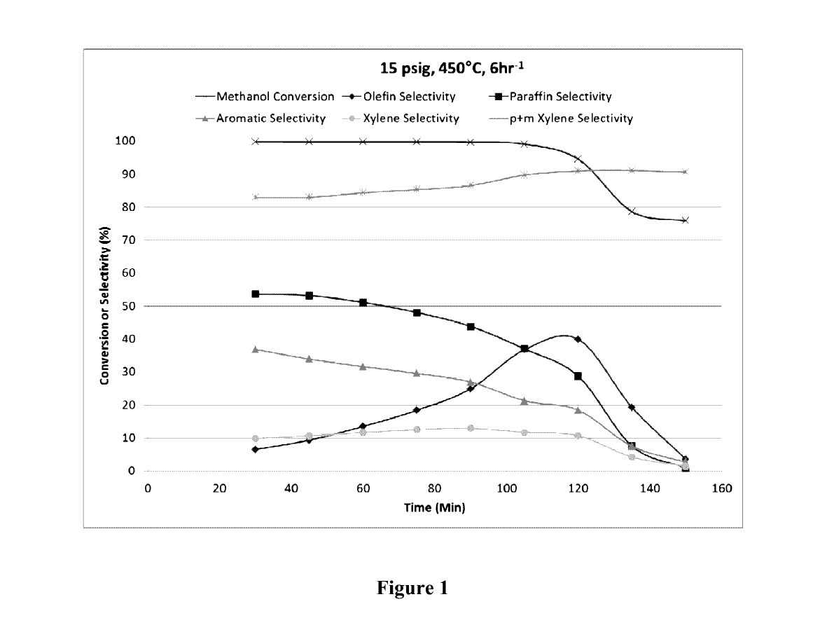

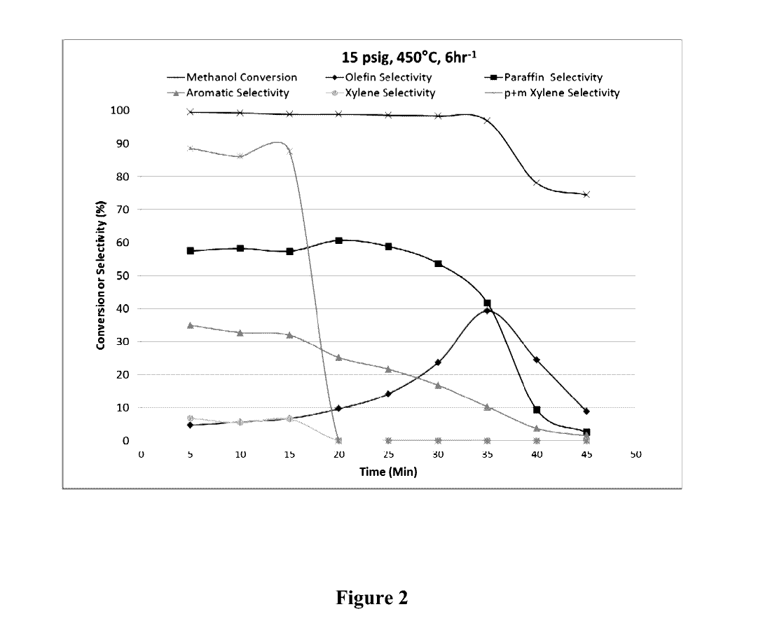

As shown in Table 1 below, silicon selectivation of HZSM-5 significantly reduces or eliminates the production of durene in the conversion of methanol to gasoline. FIGS. 1 and 2 show conversion and/or selectivity for methanol conversion to hydrocarbons using silicon selectivated HZSM-5 (2×) and silicon selectivated HZSM-5 (3×), respectively.

Alternately, silicon selectivation can tailor the production of aromatics favoring the production of toluene and improve p-xylene selectivity.

TABLE 1

| | Silicon | Silicon |
|---|---|---|
| | Selectivated | Selectivated |
| Summary | HZSM-5(2X) | HZSM-5(3X) |
| Time on Stream | 30 | 15 |
| % Methanol | 99.8 | 98.9 |
| Conversion | | |

Product Distribution in HC Phase

| | | |
|---|---|---|
| Olefins | 6 | 7 |
| Paraffins | 54 | 57 |
| Aromatics | 37 | 32 |
| Methane (CH4) | 2.9 | 2.6 |

Olefins

| | | |
|---|---|---|
| C2 | 1.9 | 2.0 |
| C3 | 2.9 | 2.5 |
| C4 | 1.3 | 1.8 |
| C5 | 0.3 | 0.4 |

Paraffins

| | | |
|---|---|---|
| C2 | 1.6 | 1.9 |
| C3 | 25.3 | 27.5 |
| C4 | 19.6 | 20.1 |
| C5 | 5.6 | 5.8 |
| C6 | 1.5 | 1.8 |
| C7 | 0.0 | 0.0 |
| C8 | 0.0 | 0.2 |

Aromatics

| | | |
|---|---|---|
| C6 | 4.4 | 4.5 |
| C7 | 17.6 | 19.4 |
| C8 | 10.5 | 7.3 |
| Ethylbenzene | 0.7 | 0.8 |
| Para + Meta Xylene | 8.7 | 6.4 |
| Orthoxylene | 1.1 | 0.1 |
| % p + m Xylene | 82.9 | 87.6 |
| C9 | 1.5 | 0.4 |
| C10 | 0.3 | 0.0 |
| C11 | 0.9 | 0.0 |
| Unknown | 1.7 | 0.3 |

1. A process for converting an oxygenate feedstock to a hydrocarbon product comprising:
feeding the oxygenate feedstock to a reactor under conditions to convert at least a portion of the oxygenate feedstock to the hydrocarbon product in a reactor effluent,
wherein the reactor comprises a catalyst selected from the group consisting of a selectivated zeolite, a SAPO, a selectivated SAPO, an ALPO and a selectivated ALPO, and
wherein a hydrocarbon portion of reactor effluent comprises less than about 8 wt. % durene and less than about 0.5 wt. % C₁₂₊ aromatics; and
separating a C₅₊ gasoline product from the reactor effluent.

2. The process of claim 1, wherein the reactor is a moving bed reactor, a fixed bed reactor or a fluidized bed reactor.

3. The process of claim 1, wherein the reactor is a fluidized bed reactor.

4. The process of claim 1, wherein the oxygenate feedstock comprises methanol and/or dimethyl ether, optionally containing water.

5. The process of claim 1, wherein the hydrocarbon portion of the reactor effluent further comprises benzene.

6. The process of claim 5, wherein benzene is present in an amount of at least about 4.0 wt. %.

7. The process of claim 1, wherein durene is present in an amount of less than about 2.5 wt. %.

8. The process of claim 1, wherein the temperature in the reactor is about 550° F. to about 1000° F.

9. The process of claim 1, wherein the pressure in the reactor is about 10 psig to about 500 psig.

10. The process of claim 1, wherein the selectivated zeolite, the selectivated SAPO and the selectivated ALPO are each independently steam selectivated, silicon selectivated and/or phosphorous selectivated.

11. The process of claim 1, wherein the catalyst is selected from the group consisting of SAPO's, ZSM-5, ZSM-11, ZSM-12, ZSM-22, ZSM-23, ZSM-35, ZSM-48, ZSM-50, ZSM-57, and intergrowths and combinations thereof.

12. The process of claim 1, wherein the selectivated zeolite is selected from the group consisting of selectivated ZSM-5, selectivated ZSM-11, selectivated ZSM-12, selectivated ZSM-22, selectivated ZSM-23, selectivated ZSM-35, selectivated ZSM-48, selectivated ZSM-50, selectivated ZSM-57 and selectivated intergrowths and combinations thereof.

13. The process of claim 1, wherein the catalyst is a silicon selectivated zeolite.

14. The process of claim 13, wherein the silicon selectivated zeolite is silicon selectivated ZSM-5.

15. The process of claim 1, wherein the SAPO is selected from the group consisting of SAPO-11, SAPO-41, and SAPO-31 and/or the ALPO is selected from the group consisting of AlPO-11, AlPO-H2, AlPO-31 and AlPO-41

16. The process of claim 1, wherein a further step of treating the reactor effluent to reduce the durene content is not present.

17. The process of claim 1, wherein a further step of pre-treating the oxygenate feedstock to reduce water content is not present.

18. The process of claim 4, wherein at least 90% of the methanol is converted into the hydrocarbon product.

19. A process for converting an oxygenate feedstock to a hydrocarbon product consisting essentially of:
feeding the oxygenate feedstock to a reactor under conditions to convert at least a portion of the oxygenate feedstock to a hydrocarbon product in a reactor effluent, wherein the reactor comprises a catalyst selected from the group consisting of a selectivated zeolite, a SAPO, a selectivated SAPO, an ALPO and a selectivated ALPO, and wherein a hydrocarbon portion of the reactor effluent comprises less than about 8.0 wt. % durene and less than about 0.5 wt. % C₁₂₊ aromatics; and
separating a C₅₊ gasoline product from the reactor effluent.

20. A process for converting an oxygenate feedstock to a hydrocarbon product comprising: feeding the oxygenate feedstock to a reactor under conditions to convert at least a portion of the oxygenate feedstock to the hydrocarbon product in a reactor effluent, wherein the reactor comprises a silicon selectivated zeolite catalyst, and wherein a hydrocarbon portion of the reactor effluent comprises less than about 2.5 wt. % durene and less than about 0.5 wt. % C₁₂₊ aromatics prior to: (i) separating a C₅₊ gasoline product from the reactor effluent; and/or (ii) heavy gasoline treatment of the reactor effluent.

21. A process for reducing off-spec gasoline production during start-up of an MTG conversion process comprising:
at start-up feeding a feedstock comprising methanol and/or dimethylether to a reactor under conditions to convert at least a portion of the feedstock to a C₅₊ gasoline product in a reactor effluent, wherein the reactor comprises a silicon selectivated zeolite catalyst, and wherein a hydrocarbon portion of the reactor effluent comprises:
less than about 2.5 wt. % durene; and
less than about 0.5 wt. % C₁₂₊ aromatics.

22. A system for converting an oxygenate feedstock to a C₅₊ gasoline product comprising:
a reactor comprising:
an oxygenate feedstock stream and an inlet for the oxygenate feedstock stream;
a catalyst selected from the group consisting of a selectivated zeolite, a SAPO, a selectivated SAPO, an ALPO and a selectivated ALPO;
a reactor effluent stream and an outlet for the reactor effluent stream, wherein a hydrocarbon portion of the reactor effluent stream comprises less than about 8.0 wt. % durene and less than about 0.5 wt. % C₁₂₊ aromatics; and
a separation system in fluid connection with the reactor for separating the C₅₊ gasoline product from the reactor effluent stream comprising:
an inlet for the reactor effluent stream;
C₅₊ gasoline product stream and
an outlet for the C₅₊ gasoline product stream.

23. The system of claim 22, wherein the reactor is a moving bed reactor, a fixed bed reactor or a fluidized bed reactor.

24. The system of claim 22, wherein the reactor is a fluidized bed reactor.

25. The system of claim 22, wherein the oxygenate feedstock stream comprises methanol and/or dimethyl ether, optionally containing water.

26. The system of claim 22, wherein the hydrocarbon portion of the reactor effluent stream further comprises benzene.

27. The system of claim 26, wherein benzene is present in an amount of at least about 4.0 wt. %.

28. The system of claim 22, wherein durene is present in an amount of less than about 2.5 wt. %.

29. The system of claim 22, wherein the selectivated zeolite, the selectivated SAPO and the selectivated ALPO are each independently steam selectivated, silicon selectivated and/or phosphorous selectivated.

30. The system of claim 22, wherein the selectivated zeolite is selected from the group consisting of selectivated ZSM-5, selectivated ZSM-11, selectivated ZSM-12, selectivated ZSM-22, selectivated ZSM-23, selectivated ZSM-35, selectivated ZSM-48, selectivated ZSM-50, selectivated ZSM-57 and selectivated intergrowths and combinations thereof.

31. The system of claim 22, wherein the catalyst is a silicon selectivated zeolite.

32. The system of claim 31, wherein the silicon selectivated zeolite is silicon selectivated ZSM-5.

33. The system of claim 22, wherein the SAPO is selected from the group consisting of SAPO-11, SAPO-41, and SAPO-31 and/or the ALPO is selected from the group consisting of AlPO-11, AlPO-H2, AlPO-31 and AlPO-41

34. The system of claim 22, wherein a reactor for reducing durene content is not present.

35. The system of claim 22, wherein an apparatus for reducing water content in the oxygenate feedstock is not present.

36. A system for converting an oxygenate feedstock to a C₅₊ gasoline product consisting essentially of:
a reactor comprising:
an oxygenate feedstock stream and an inlet for the oxygenate feedstock stream;
a catalyst selected from the group consisting of a selectivated zeolite, a SAPO, a selectivated SAPO, an ALPO and a selectivated ALPO; and
a reactor effluent stream and an outlet for the reactor effluent stream, wherein a hydrocarbon portion of the reactor effluent stream comprises less than about 8 wt. % durene and less than about 0.5 wt. % C₁₂₊ aromatics; and
a separation system in fluid connection with the reactor for separating the C₅₊ gasoline product from the reactor effluent stream comprising:
an inlet for the reactor effluent stream;
a C₅₊ gasoline product stream and an outlet for the C₅₊ gasoline product stream.

37. A silicon selectivated zeolite catalyst for use in oxygenate conversion to a hydrocarbon product, wherein the hydrocarbon product produced during the oxygenate conversion has a durene content of less than about 2.5 wt. %, a benzene content of at least about 4.0 wt. % and optionally a C₁₂₊ aromatics content of less than 0.5 wt. %.

38. A methanol-to-gasoline (MTG) hydrocarbon product comprising a durene content of less than about 2.5 wt. % and a benzene content of at least about 4.0 wt. % at one or more of the following:
a. prior to separating a C₅₊ gasoline product from the MTG hydrocarbon product;
b. prior to heavy gasoline treatment of the MTG hydrocarbon product; and/or
c. produced directly in an MTG reactor.

39. An MTG hydrocarbon product comprising a durene content of less than about 2.5 wt. % and a benzene content of at least about 4.0 wt. %, wherein the MTG hydrocarbon product is present in an MTG reactor.

40. An MTG reactor comprising:
a silicon selectivated zeolite catalyst; and
an MTG hydrocarbon product comprising a durene content of less than about 2.5 wt. %
and a benzene content of at least about 4.0 wt. %.
